(19) United States
(12) Patent Application Publication
(10) Pub. No.: US 2025/0162479 A1
(43) Pub. Date: May 22, 2025

(54) VEHICLE SEAT

(71) Applicant: TS TECH CO., LTD., Asaka-shi, Saitama (JP)

(72) Inventors: Wataru HIRATSUKA, Shioya-gun, Tochigi (JP); Tsukasa MEGURO, Shioya-gun, Tochigi (JP); Kazuki TOBITA, Shioya-gun, Tochigi (JP); Masaki TANAKA, Shioya-gun, Tochigi (JP); Taiki TAKEUCHI, Shioya-gun, Tochigi (JP); Hideki USAMI, Shioya-gun, Tochigi (JP); Akihito KOBAYASHI, Shioya-gun, Tochigi (JP); Jinichi TANABE, Shioya-gun, Tochigi (JP); Makoto SHIBUYA, Shioya-gun, Tochigi (JP); Yuki YOSHIOKA, Shioya-gun, Tochigi (JP); Heehyeok PARK, Shioya-gun, Tochigi (JP); Hiroyuki KOZUTSUMI, Shioya-gun, Tochigi (JP); Momoko MORIOKA, Shioya-gun, Tochigi (JP); Yasutaka KOHATA, Shioya-gun, Tochigi (JP); Takayoshi ITO, Shioya-gun, Tochigi (JP); Akira MIYOSHI, Shioya-gun, Tochigi (JP)

(21) Appl. No.: 18/839,327

(22) PCT Filed: Apr. 20, 2023
(86) PCT No.: PCT/JP2023/006029

§ 371 Date: Aug. 16, 2024

Related U.S. Application Data
(60) Provisional application No. 63/320,815, filed on Mar. 17, 2022.
(60) Provisional application No. 63/323,186, filed on Mar. 24, 2022.
(60) Provisional application No. 63/324,763, filed on Mar. 29, 2022.

(30) Foreign Application Priority Data
Feb. 18, 2022 (JP) 2022-023379

(51) Int. Cl. B60N 2/68; B60N 2/22

(52) U.S. Cl. CPC B60N 2/68; B60N 2/22

(57) ABSTRACT

A seat includes a seat cushion frame and a seat back frame. The seat cushion frame includes left and right side members extending in a front-and-rear direction, a front member extending in a lateral direction and coupled to a front portion of each of the side members, a rear member extending in the lateral direction and coupled to a rear portion of each of the side members, and support members coupled to a rear end of each of the side members and extending upward. At least one of the support members includes a support member lower portion coupled to a laterally outer surface of the side member, and a support member upper portion extending upward and laterally inward from the support member lower portion and rotatably supporting the seat back frame. When viewed in an up-and-down direction, the support member upper portion overlaps with the side member.

### TECHNICAL FIELD

The present invention relates to a vehicle seat that is installed in a vehicle and the like.

### BACKGROUND ART

Patent Document 1 discloses a vehicle seat including a seat cushion frame, and a seat back frame provided rotatably relative to the seat cushion frame. The seat cushion frame includes left and right side members extending in the front-and-rear direction, and support members coupled to laterally outer surfaces of rear ends of the side members. The seat back frame is rotatably supported by the support members. The support member is formed in a plate shape, and is formed in a flat shape upward from a laterally outer surface of the side member.

### PRIOR ART DOCUMENT(S)

### Patent Document(s)

Patent Document 1: JP2022-114148A

### SUMMARY OF THE INVENTION

### Task to be Accomplished by the Invention

When the vehicle collides, a load is applied from an occupant to a seat back. Accordingly, the support member is required to resist this load. However, when the support member is formed into a flat plate, the plate thickness is increased in order to improve the rigidity, which increases the weight and material costs.

In view of the above background, an object of the present invention is to suppress the deformation of a support member for supporting a seat back frame in a vehicle seat.

### Means to Accomplish the Task

To achieve such an object, one aspect of the present invention provides a vehicle seat (1) comprising: a seat cushion frame (11); and a seat back frame (12) rotatably supported by the seat cushion frame, wherein the seat cushion frame includes: left and right side members (21) extending in a front-and-rear direction: a front member (22) extending in a lateral direction and coupled to a front portion of each of the side members; a rear member (23) extending in the lateral direction and coupled to a rear portion of each of the side members: and support members (24) coupled to a rear end of each of the side members and extending upward, at least one of the support members includes: a support member lower portion (24A) coupled to a laterally outer surface of the side member; and a support member upper portion (24B) extending upward and laterally inward from the support member lower portion and rotatably supporting the seat back frame, and when viewed in an up-and-down direction, the support member upper portion overlaps with the side member.

According to this aspect, when a load is applied to a seat back and the support member deforms downward, the support member upper portion abuts against the side member, which suppresses the deformation of the support member. Accordingly, it is possible to suppress the deformation of the support member for supporting the seat back frame in the vehicle seat. Further, it is possible to reduce the weight and material of the support member.

In the above aspect, preferably, the side member includes: a side member body (21A) extending in the front-and-rear direction; and a side member extension (21B) protruding upward from a rear end of the side member body, the support member lower portion is coupled to the side member extension, and when viewed in the up-and-down direction, the support member upper portion overlaps with the side member extension.

According to this aspect, when a load is applied to the seat back and the support member deforms downward, the support member upper portion abuts against the side member extension, which suppresses the deformation of the support member.

In the above aspect, preferably, one of the side member extension and the support member lower portion is provided with a protrusion (21C) extending in the up-and-down direction, and another of the side member extension and the support member lower portion is provided with a receiving groove (24D) that receives the protrusion.

According to this aspect, the protrusion enters the receiving groove, which stabilizes the position of the support member lower portion relative to the side member extension.

In the above aspect, preferably, the protrusion is provided on each of front and rear edges of the side member extension, and the receiving groove is provided on each of front and rear edges of the support member lower portion.

According to this aspect, the front and rear protrusions enter the receiving grooves, which stabilizes the position of the support member lower portion relative to the side member extension.

In the above aspect, preferably, the support member is formed of a sheet metal member, and edge walls (24E) protruding laterally outward and extending from the support member lower portion to the support member are provided on front and rear edges of the support member.

According to this aspect, the rigidity of the support member is improved.

In the above aspect, preferably, a reinforcement plate (35) is provided on a laterally outer surface of the support member, and the reinforcement plate is coupled to the front and rear edge walls.

According to this aspect, the rigidity of the support member is improved.

In the above aspect, preferably, the support member upper portion is provided with a bulging portion (24F) bulging laterally inward, the seat back frame is rotatably supported by the bulging portion, and the bulging portion is spaced upward relative to an upper edge of the side member extension.

According to this aspect, when a load is applied to the seat back and the support member deforms downward, the bulging portion abuts against the side member extension, which suppresses the deformation of the support member. Further, the bulging portion improves the rigidity of the support member.

In the above aspect, preferably, the left and right side members are coupled to a floor (7) via a slide device (6), the slide device includes: a lower rail (15) coupled to the floor; and an upper rail (16) provided slidably relative to the lower rail and coupled to the side member, the lower rail is provided with a lower locking member (61) extending in the front-and-rear direction and having a tip end facing downward, the side member is provided with an upper locking member (63) extending in the front-and-rear direction and having a tip end facing upward, the upper locking member faces the lower locking member from below with a gap therebetween, and is coupled to the side member at a front coupling portion (65) and a rear coupling portion (66) that are spaced in the front-and-rear direction, a coupling portion (23A) of the rear member and the side member is provided rearward of the front coupling portion and forward of the rear coupling portion, and a coupling portion (67A) of a seat belt buckle (67) and the side member is provided rearward of the front coupling portion and forward of the coupling portion of the rear member and the side member.

According to this aspect, it is possible to couple the seat belt buckle to a rigid portion of the side member. Accordingly, the coupling portion of the seat belt buckle and the side member can resist the load applied from the occupant at a collision of the vehicle.

In the above aspect, preferably, the seat back frame includes: left and right back side members (41) extending in the up-and-down direction; an upper member (42) extending in the lateral direction and connected to upper ends of the left and right back side members; and a lower member (43) extending in the lateral direction and connected to lower ends of the left and right back side members, at least one of the back side members includes: a pipe portion (41A) extending in the up-and-down direction; and a side plate (44) coupled to a lower portion of the pipe portion, the side plate includes: a plate body (44A) extending in the up-and-down direction and facing the lateral direction; and front and rear flanges (44B, 44C) protruding laterally inward from front and rear edges of the plate body, the pipe portion includes: a straight portion (41B) extending straight in the up-and-down direction; and an inclined portion (41D) extending downward and laterally inward from a bent portion (41C) provided at a lower end of the straight portion, an upper portion of the plate body is arranged along the straight portion, a lower portion of the plate body is arranged laterally outward of the bent portion with a gap therebetween, the lower portion of the plate body is provided with a reinforcement bead (44F) extending downward of the bent portion, the support member upper portion is provided laterally outward of the lower portion of the plate body with a reclining device (50) therebetween, and a lever (50B) coupled to an operation shaft (50A) of the reclining device is arranged laterally inward of the lower portion of the plate body.

According to this aspect, it is possible to reinforce the lower portion of the plate body extending downward to be away from a side pipe by the reinforcement bead.

In the above aspect, preferably, the front flange is welded to the straight portion, and the rear flange is welded to the straight portion and the inclined portion.

According to this aspect, it is possible to stably couple the side plate to the side pipe.

Another aspect of the present invention relates to a vehicle seat. A document (JP2018-16211A) discloses a vehicle seat including a protection cover that covers a welded portion of a seat cushion frame. The protection cover includes a first cover and a second cover, and is provided so as to cover the welded portion of the seat cushion frame. To avoid the contact between the welded portion and a seat belt, a portion of the first cover is inserted inside the second cover.

However, when a portion of the first cover is inserted inside the second cover, there is a problem that the overall thickness of the protection cover becomes large. Further, since the end of the first cover cannot be seen from the outside, it is difficult to check whether the first cover is attached to an appropriate position. Accordingly, there is a problem that the positioning of the protection cover is difficult. In view of the above background, another object of the present invention is to reduce the thickness of a protection cover and facilitate the positioning of the protection cover in a vehicle seat.

Another aspect of the present invention provides a vehicle seat (401) comprising: a seat cushion (402); and a seat back (403) rotatably supported by a rear portion of the seat cushion, wherein the seat cushion includes: a seat cushion frame (405) including left and right side members (411) extending in a front-and-rear direction, a front member (412) extending in a lateral direction and connected to front ends of the left and right side members, and a rear member (413) extending in the lateral direction and connected to rear ends of the left and right side members; and a protection cover (440) provided on at least one of the left and right side members, the protection cover includes: a first cover (441); and a second cover (442) provided forward or rearward of the first cover and arranged adjacently thereto, a protrusion (443) extending toward a side of the second cover is provided at an end of the first cover on the side of the second cover, a recess (444) receiving the protrusion is provided at an end of the second cover on a side of the first cover, and the recess penetrates in a thickness direction of the second cover.

According to this aspect, since the protrusion does not overlap with the second cover in the thickness direction of the second cover, the thickness of the protection cover can be reduced. Further, since the protrusion can be seen from the outside, the positioning of the first cover and the second cover can be facilitated. Accordingly, it is possible to reduce the thickness of the protection cover and facilitate the positioning of the protection cover in the vehicle seat. Further, as the protrusion fits into the recess, a boundary between the first cover and the second cover meanders. Accordingly, the seat belt is unlikely to enter the boundary between the first cover and the second cover.

In the above aspect, preferably, the seat cushion frame includes seat back support portions (415) extending upward from rear portions of the left and right side members, and the second cover includes: a second cover front portion (453) provided rearward of the first cover and extending in the front-and-rear direction; and a second cover rear portion (454) extending rearward and upward from the second cover front portion and covering at least a portion of the seat back support portion.

According to this aspect, the protection cover can protect the seat back support portion.

In the above aspect, preferably, a thickness of the second cover front portion is greater than a thickness of the second cover rear portion.

According to this aspect, the rigidity of the second cover front portion that may receive a load from the seat belt can be increased.

In the above aspect, preferably, the vehicle seat comprises: an arm (421) welded to one of the side members and extending upward from the side member; and a support bracket (422) coupled to a vehicle body and rotatably supporting an upper end of the arm around a rotation axis (A1) extending in the front-and-rear direction, and the first cover covers a welded portion (447) of the arm and the side member.

According to this aspect, it is possible to prevent a seat belt from contacting with the welded portion of the arm and the side member.

In the above aspect, preferably, a restriction wall (49) protruding upward and extending in the lateral direction is provided on an upper surface of the first cover.

According to this aspect, the restriction wall can restrict the forward movement of the seat belt.

In the above aspect, preferably, the arm includes: an arm body (421A) extending in an up-and-down direction and the front-and-rear direction and having an upper end supported by the support bracket; and a pair of front and rear arm couplings (421B) extending laterally from a lower end of the arm body and welded to the side member, the first cover includes: a first cover upper portion (441A) arranged along the arm body; and a pair of front and rear first cover lower portions (441B) arranged along the pair of front and rear arm couplings, and the first cover lower portion is provided with the protrusion.

According to this aspect, the first cover can protect the arm that rotatably supports the seat relative to the vehicle body.

In the above aspect, preferably, the seat cushion includes: a pad (406) supported by the seat cushion frame; and a skin material (407) covering the pad, and the skin material covers the first cover lower portion and the second cover front portion.

According to this aspect, the skin material can cover the boundary between the first cover and the second cover. Accordingly, the seat belt is unlikely to enter the boundary between the first cover and the second cover.

In the above aspect, preferably, a rib (456) extending in the lateral direction is provided on a back of the second cover front portion.

According to this aspect, the rigidity of the second cover front portion can be increased.

In the above aspect, preferably, the second cover front portion includes: a sidewall (453A) arranged laterally outward of the side member; and an upper wall (453B) extending laterally inward from an upper edge of the sidewall, and the rib extends from a back of the upper wall to a back of the sidewall.

According to this aspect, the rigidity of the second cover front portion can be increased.

In the above aspect, preferably, the recess is formed on the upper wall.

According to this aspect, it is possible to cause the boundary between the first cover and the second cover to meander in a portion thereof with which the seat belt may contact.

### Effect of the Invention

To achieve such an object, one aspect of the present invention provides a vehicle seat (1) comprising: a seat cushion frame (11); and a seat back frame (12) rotatably supported by the seat cushion frame, wherein the seat cushion frame includes: left and right side members (21) extending in a front-and-rear direction; a front member (22) extending in a lateral direction and coupled to a front portion of each of the side members; a rear member (23) extending in the lateral direction and coupled to a rear portion of each of the side members; and support members (24) coupled to a rear end of each of the side members and extending upward, at least one of the support members includes: a support member lower portion (24A) coupled to a laterally outer surface of the side member; and a support member upper portion (24B) extending upward and laterally inward from the support member lower portion and rotatably supporting the seat back frame, and when viewed in an up-and-down direction, the support member upper portion overlaps with the side member.

According to this aspect, when a load is applied to a seat back and the support member deforms downward, the support member upper portion abuts against the side member, which suppresses the deformation of the support member. Accordingly, it is possible to suppress the deformation of the support member for supporting the seat back frame in the vehicle seat. Further, it is possible to reduce the weight and material of the support member.

In the above aspect, preferably, the side member includes: a side member body (21A) extending in the front-and-rear direction; and a side member extension (21B) protruding upward from a rear end of the side member body, the support member lower portion is coupled to the side member extension, and when viewed in the up-and-down direction, the support member upper portion overlaps with the side member extension.

According to this aspect, when a load is applied to the seat back and the support member deforms downward, the support member upper portion abuts against the side member extension, which suppresses the deformation of the support member.

In the above aspect, preferably, one of the side member extension and the support member lower portion is provided with a protrusion (21C) extending in the up-and-down direction, and another of the side member extension and the support member lower portion is provided with a receiving groove (24D) that receives the protrusion.

According to this aspect, the protrusion enters the receiving groove, which stabilizes the position of the support member lower portion relative to the side member extension.

In the above aspect, preferably, the protrusion is provided on each of front and rear edges of the side member extension, and the receiving groove is provided on each of front and rear edges of the support member lower portion.

According to this aspect, the front and rear protrusions enter the receiving grooves, which stabilizes the position of the support member lower portion relative to the side member extension.

In the above aspect, preferably, the support member is formed of a sheet metal member, and edge walls (24E) protruding laterally outward and extending from the support member lower portion to the support member are provided on front and rear edges of the support member.

According to this aspect, the rigidity of the support member is improved.

In the above aspect, preferably, a reinforcement plate (35) is provided on a laterally outer surface of the support member, and the reinforcement plate is coupled to the front and rear edge walls.

According to this aspect, the rigidity of the support member is improved.

In the above aspect, preferably, the support member upper portion is provided with a bulging portion (24F) bulging laterally inward, the seat back frame is rotatably supported by the bulging portion, and the bulging portion is spaced upward relative to an upper edge of the side member extension.

According to this aspect, when a load is applied to the seat back and the support member deforms downward, the bulging portion abuts against the side member extension, which suppresses the deformation of the support member. Further, the bulging portion improves the rigidity of the support member.

In the above aspect, preferably, the left and right side members are coupled to a floor (7) via a slide device (6), the slide device includes: a lower rail (15) coupled to the floor; and an upper rail (16) provided slidably relative to the lower rail and coupled to the side member, the lower rail is provided with a lower locking member (61) extending in the front-and-rear direction and having a tip end facing downward, the side member is provided with an upper locking member (63) extending in the front-and-rear direction and having a tip end facing upward, the upper locking member faces the lower locking member from below with a gap therebetween, and is coupled to the side member at a front coupling portion (65) and a rear coupling portion (66) that are spaced in the front-and-rear direction, a coupling portion (23A) of the rear member and the side member is provided rearward of the front coupling portion and forward of the rear coupling portion, and a coupling portion (67A) of a seat belt buckle (67) and the side member is provided rearward of the front coupling portion and forward of the coupling portion of the rear member and the side member.

According to this aspect, it is possible to couple the seat belt buckle to a rigid portion of the side member. Accordingly, the coupling portion of the seat belt buckle and the side member can resist the load applied from the occupant at a collision of the vehicle.

In the above aspect, preferably, the seat back frame includes: left and right back side members (41) extending in the up-and-down direction; an upper member (42) extending in the lateral direction and connected to upper ends of the left and right back side members; and a lower member (43) extending in the lateral direction and connected to lower ends of the left and right back side members, at least one of the back side members includes: a pipe portion (41A) extending in the up-and-down direction; and a side plate (44) coupled to a lower portion of the pipe portion, the side plate includes: a plate body (44A) extending in the up-and-down direction and facing the lateral direction; and front and rear flanges (44B, 44C) protruding laterally inward from front and rear edges of the plate body, the pipe portion includes: a straight portion (41B) extending straight in the up-and-down direction; and an inclined portion (41D) extending downward and laterally inward from a bent portion (41C) provided at a lower end of the straight portion, an upper portion of the plate body is arranged along the straight portion, a lower portion of the plate body is arranged laterally outward of the bent portion with a gap therebetween, the lower portion of the plate body is provided with a reinforcement bead (44F) extending downward of the bent portion, the support member upper portion is provided laterally outward of the lower portion of the plate body with a reclining device (50) therebetween, and a lever (50B) coupled to an operation shaft (50A) of the reclining device is arranged laterally inward of the lower portion of the plate body.

According to this aspect, it is possible to reinforce the lower portion of the plate body extending downward to be away from a side pipe by the reinforcement bead.

In the above aspect, preferably, the front flange is welded to the straight portion, and the rear flange is welded to the straight portion and the inclined portion.

According to this aspect, it is possible to stably couple the side plate to the side pipe.

### BRIEF DESCRIPTION OF THE DRAWING(S)

FIG. 1 is a perspective view of a frame of a seat according to an embodiment;

FIG. 2 is a perspective view showing a support structure of a first seat back frame;

FIG. 3 is a perspective view showing the support structure of the first seat back frame;

FIG. 4 is a front view showing the support structure of the first seat back frame;

FIG. 5 is a horizontal cross-sectional view of a coupling portion of a side member and a support member;

FIG. 6 is a vertical cross-sectional view of the coupling portion of the side member and the support member;

FIG. 7 is a perspective view showing a lower structure of the first seat back frame;

FIG. 8 is a right side view of the seat;

FIG. 9 is an IX-IX cross-sectional view of FIG. 8;

FIG. 10 is a side view of a seat in a drive mode according to another embodiment;

FIG. 11 is an explanatory diagram of a seat cushion in a soft mode;

FIG. 12 is an explanatory diagram of the seat cushion in a hard mode;

FIG. 13 is a side view of the seat in a peace mode;

FIG. 14 is a perspective view of a seat back frame according to another embodiment;

FIG. 15 is a horizontal cross-sectional view of a pressure receiving member;

FIG. 16 is an explanatory diagram showing a vehicle in which a seat according to another embodiment is provided;

FIG. 17 is an explanatory diagram showing attachment positions of a plurality of seats in a vehicle cabin;

FIG. 18 is a perspective view of a slide device;

FIG. 19 is a perspective cross-sectional view of an upper rail;

FIG. 20 is an explanatory diagram showing the attachment positions of the plurality of seats in the vehicle cabin;

FIG. 21 is an explanatory diagram showing the attachment positions of the plurality of seats in the vehicle cabin;

FIG. 22 is an explanatory diagram showing the attachment positions of the plurality of seats in the vehicle cabin;

FIG. 23 is a perspective view showing a use mode of a seat according to another embodiment:

FIG. 24 is a perspective view showing a storage mode of the seat;

FIG. 25 is a perspective view showing a frame of the seat;

FIG. 26 is a perspective view showing a coupling portion of an arm and a seat cushion frame;

FIG. 27 is a plan view showing the seat cushion frame to which a protection cover is attached;

FIG. 28 is a perspective view in which a boundary between a first cover and a second cover is viewed from an upper left side;

FIG. 29 is a perspective view of the first cover and the second cover; and

FIG. 30 is a cross-sectional view of a seat cushion.

### MODE(S) FOR CARRYING OUT THE INVENTION

In the following, an embodiment in which a vehicle seat according to the present invention is applied to a rear seat (including a seat in a second row or a third row) of an automobile will be described with reference to the drawings. In the following description, the central side of a seat in the lateral direction will be referred to as “inward”, and the opposite side thereof will be referred to as “outward”. A pair of left and right components having the same configuration will be given the same reference numerals, and their description will be omitted.

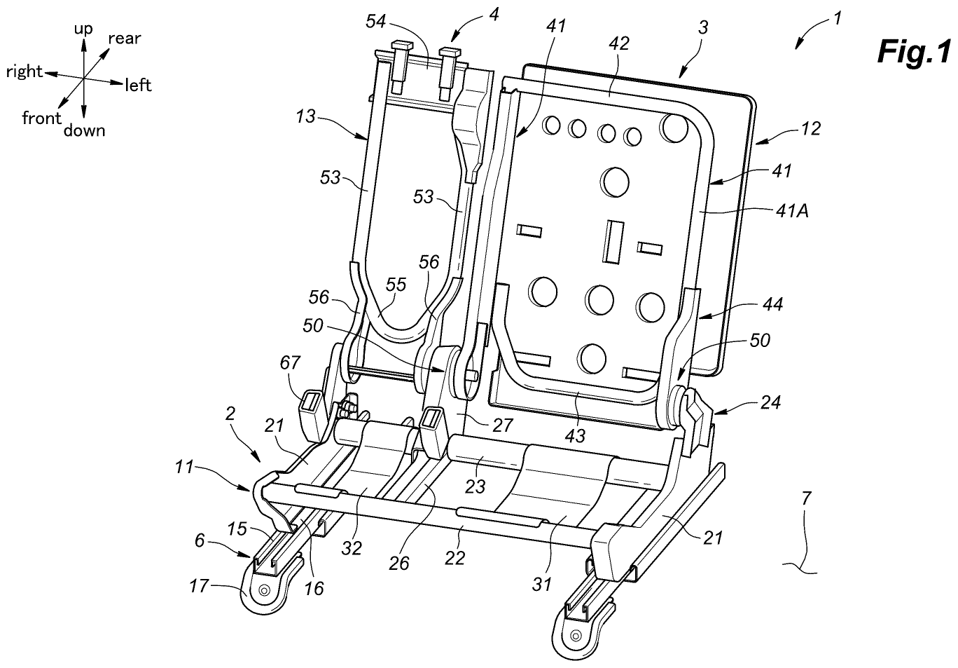

As shown in FIG. 1, a seat 1 includes a seat cushion 2 that supports the buttocks of a user from below, and a first seat back 3 and a second seat back 4 that support the back of the user from behind. The first seat back 3 is arranged leftward of the second seat back 4. The seat cushion 2 is supported by a floor 7 via a slide device 6. The first seat back 3 is rotatably supported by a rear left portion of the seat cushion 2. The second seat back 4 is rotatably supported by a rear right portion of the seat cushion 2.

The seat cushion 2 includes a seat cushion frame 11. The first seat back 3 includes a first seat back frame 12. The second seat back 4 includes a second seat back frame 13. The seat cushion frame 11, the first seat back frame 12, and the second seat back frame 13 are each provided with a flexible pad, and the pad is covered with a skin material.

The slide device 6 includes lower rails 15 coupled to the floor 7, and upper rails 16 provided slidably relative to the lower rails 15. A pair of left and right lower rails 15 are provided, and extend in the front-and-rear direction. The lower rail 15 is coupled to the floor 7 via a foot 17.

The seat cushion frame 11 includes left and right side members 21 extending in the front-and-rear direction, a front member 22 extending in the lateral direction and coupled to a front portion of each side member 21, a rear member 23 extending in the lateral direction and coupled to a rear portion of each side member 21, and support members 24 coupled to a rear end of each side member 21 and extending upward.

The seat cushion frame 11 includes an intermediate member 26 extending between the left and right side members 21 in the front-and-rear direction and coupled to the front member 22 and the rear member 23, and an intermediate support member 27 coupled to a rear end of the intermediate member 26 and extending upward. Further, the seat cushion frame 11 includes a left pan frame 31 extending in the front-and-rear direction between the left side member 21 and the intermediate member 26 and coupled to the front member 22 and the rear member 23, and a right pan frame 32 extending in the front-and-rear direction between the right side member 21 and the intermediate member 26 and coupled to the front member 22 and the rear member 23.

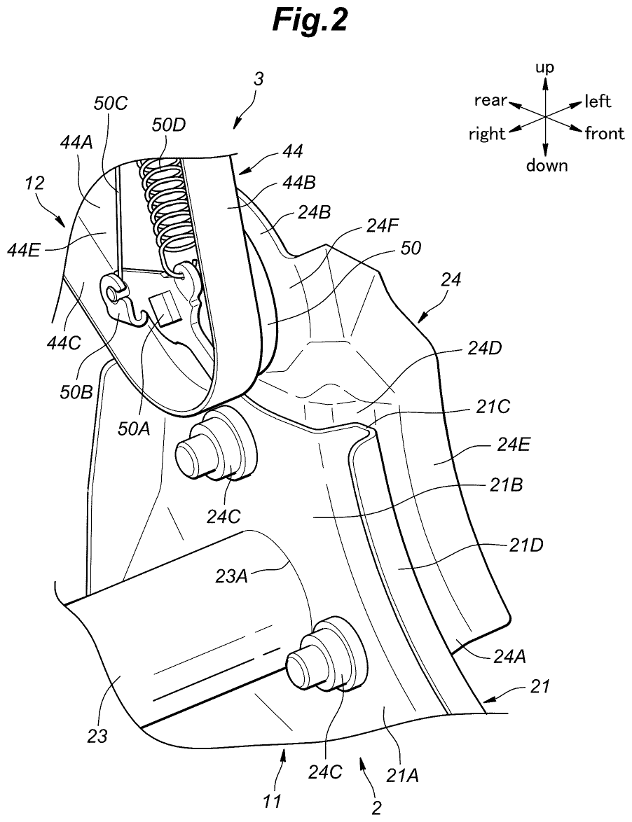

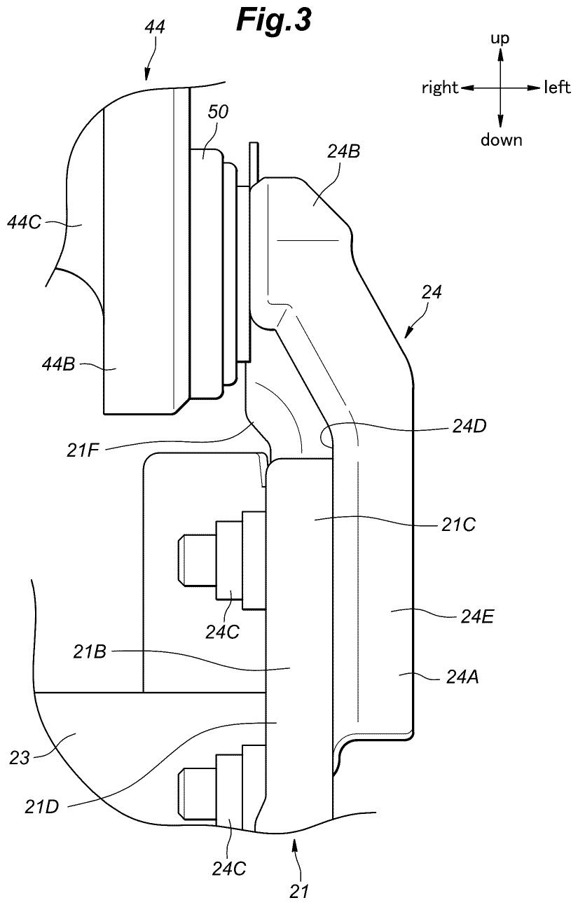

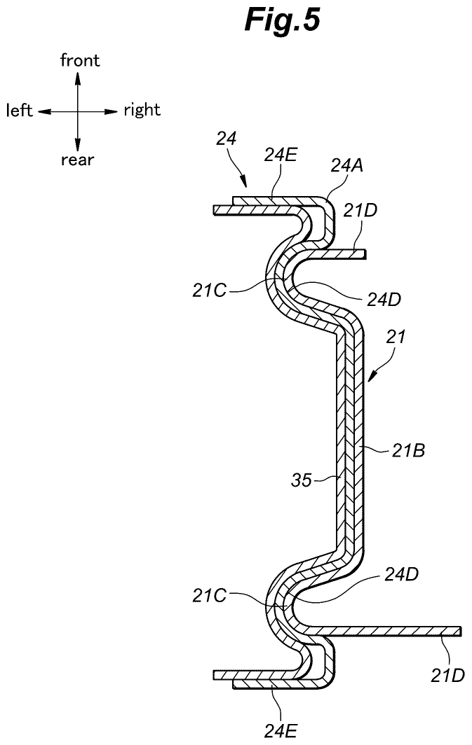

As shown in FIGS. 1 to 4, each side member 21 is formed of a sheet metal member. Each side member 21 is coupled to the upper rail 16 corresponding thereto with respect to the lateral direction. Each side member 21 includes a side member body 21A extending in the front-and-rear direction, and a side member extension 21B protruding upward from a rear end of the side member body 21A. The side member body 21A and the side member extension 21B are formed integrally, and have a main surface facing the lateral direction. As shown in FIGS. 2 and 5, the side member extension 21B is provided with protrusions 21C protruding laterally outward and extending in the up-and-down direction. The protrusions 21C are provided at front and rear edges of the side member extension 21B, respectively. At the front and rear edges of the side member extension 21B, edge walls 21D protruding laterally inward are provided. The protrusions 21C and the edge walls 21D are formed by press forming of a sheet metal member. The edge walls 21D extend along edges of the side member body 21A. The front and rear protrusions 21C are arranged between the front and rear edge walls 21D. The front edge wall 21D is continuous with the front protrusion 21C, and the rear edge wall 21D is continuous with the rear protrusion 21C. The cross section of the protrusion 21C may be semicircular.

As shown in FIGS. 2 to 4, each support member 24 is formed of a sheet metal member. A main surface of the support member 24 faces the lateral direction. At least one of the support members 24 includes a support member lower portion 24A coupled to a laterally outer surface of the side member 21, and a support member upper portion 24B extending upward and laterally inward from the support member lower portion 24A and rotatably supporting the first seat back frame 12. In the present embodiment, the support member upper portion 24B of the left support member 24 extends upward and laterally inward from the support member lower portion 24A. The support member upper portion 24B of the right support member 24 extends upward from the support member lower portion 24A. The left and right support member lower portions 24A are coupled to the left and right side member extensions 21B. The rear member 23 is welded to a lower portion of the side member extension 21B. The support member lower portion 24A may be fastened to the side member extension 21B via at least three fastening portions 24C. A front fastening portion 24C may be arranged in front of the rear member 23, and a rear fastening portion 24C may be arranged at the rear of the rear member 23. An upper fastening portion 24C may be arranged above the rear member 23. The upper fastening portion 24C may be provided at an upper end of the side member extension 21B.

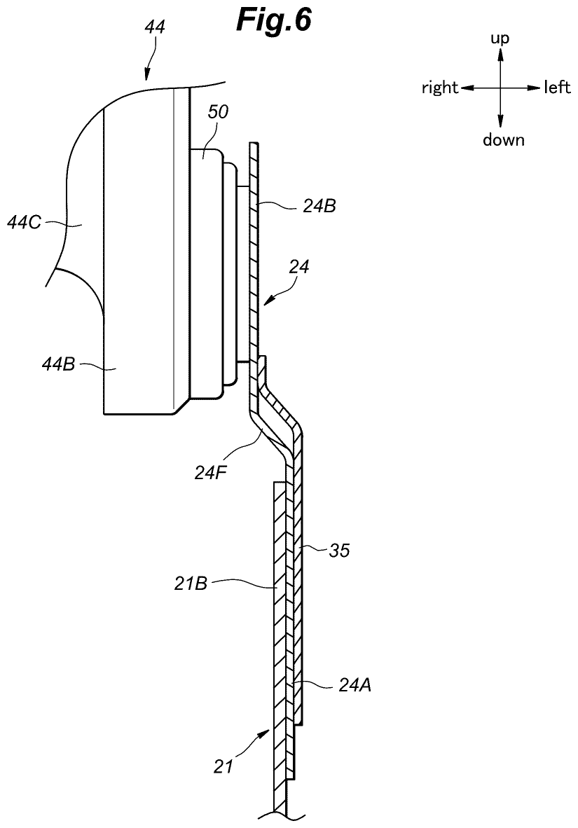

As shown in FIGS. 2, 3, and 6, when viewed in the up-and-down direction, the left support member upper portion 24B overlaps with the left side member 21. More specifically, when viewed in the up-and-down direction, the left support member upper portion 24B overlaps with the left side member extension 21B.

As shown in FIG. 5, the support member lower portion 24A is provided with receiving grooves 24D that receive the protrusions 21C. The receiving grooves 24D are provided on front and rear edges of the support member lower portion 24A, respectively. In a state where the support member lower portion 24A is coupled to the side member extension 21B, the protrusions 21C corresponding to the front and rear receiving grooves 24D with respect to the front-and-rear direction fit into the front and rear receiving grooves 24D. Accordingly, it is possible to stabilize the position of the support member lower portion 24A relative to the side member extension 21B. As shown in FIGS. 2 to 4, edge walls 24E protruding laterally outward and extending from the support member lower portion 24A to the support member 24 are provided on front and rear edges of the support member 24. The edge walls 24E improve the rigidity of the support member 24.

The support member upper portion 24B is provided with a bulging portion 24F bulging laterally inward. The first seat back frame 12 is rotatably supported by the bulging portion 24F. The bulging portion 24F is spaced upward relative to an upper edge of the side member extension 21B. The bulging portion 24F is arranged laterally inward relative to the support member lower portion 24A. The bulging portion 24F increases the rigidity of the support member 24.

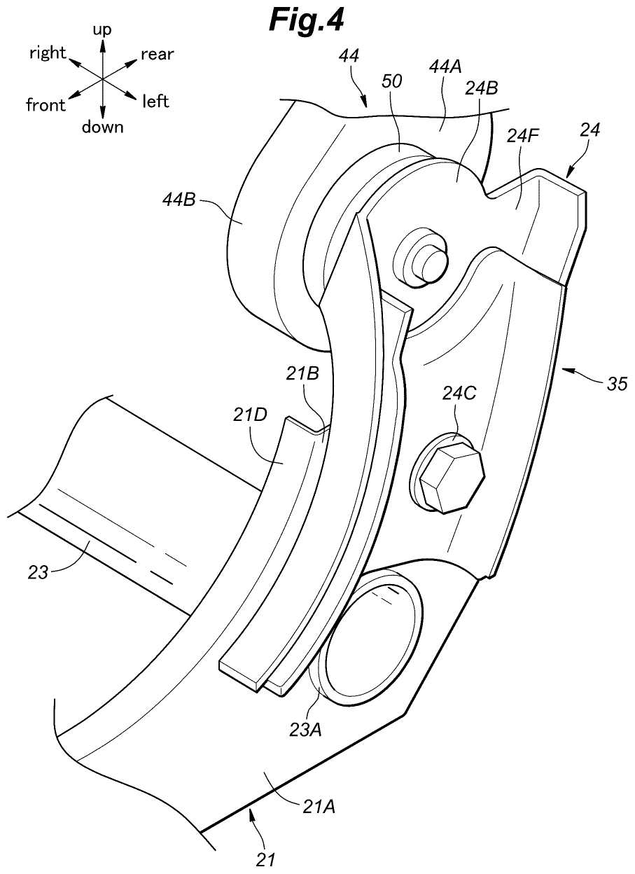

As shown in FIG. 4, a reinforcement plate 35 is provided on a laterally outer surface of the support member 24. The reinforcement plate 35 is coupled to the front and rear edge walls 24E, and forms a closed cross-sectional structure together with the support member 24. The reinforcement plate 35 increases the rigidity of the support member 24.

As shown in FIG. 1, the first seat back frame 12 is rotatably supported by the seat cushion frame 11. The first seat back frame 12 includes left and right back side members 41 extending in the up-and-down direction, an upper member 42 extending in the lateral direction and connected to upper ends of the left and right back side members 41, and a lower member 43 extending in the lateral direction and connected to lower ends of the left and right back side members 41. At least one of the left and right back side members 41 includes a pipe portion 41A extending in the up-and-down direction, and a side plate 44 coupled to a lower portion of the pipe portion 41A. In the present embodiment, the left back side member 41 includes the pipe portion 41A and the side plate 44. The right back side member 41 is formed into a rectangular tube shape by a plurality of sheet metal members. The upper member 42 and the lower member 43 are formed of pipe materials. The pipe portion 41A, the upper member 42, and the lower member 43 are formed by bending a single continuous pipe.

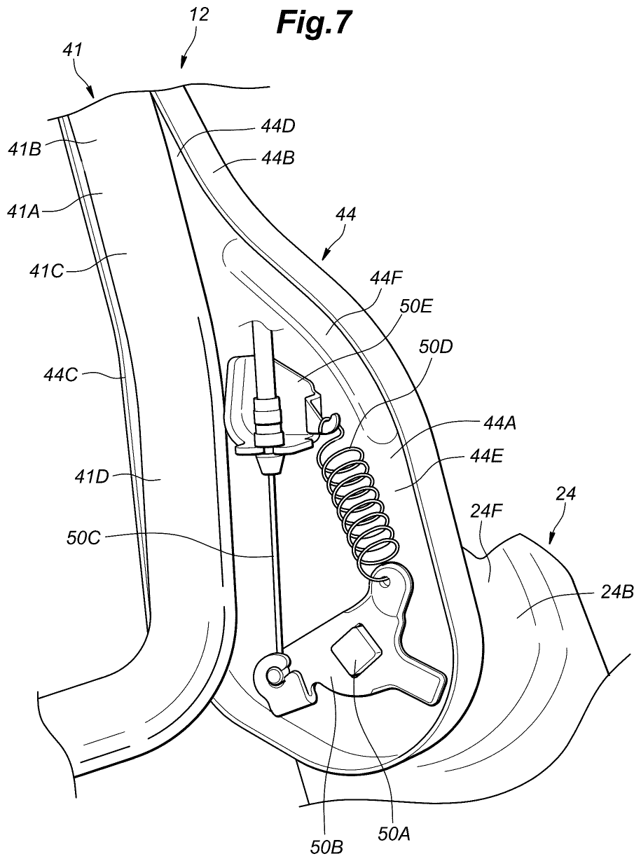

As shown in FIG. 7, the pipe portion 41A includes a straight portion 41B extending straight in the up-and-down direction, and an inclined portion 41D extending downward and laterally inward from a bent portion 41C provided at a lower end of the straight portion 41B. The side plate 44 includes a plate body 44A extending in the up-and-down direction and facing the lateral direction, and a front flange 44B and a rear flange 44C protruding laterally inward from front and rear edges of the plate body 44A. The front flange 44B is welded to the straight portion 41B. The rear flange 44C is welded to the straight portion 41B and the inclined portion 41D. Accordingly, it is possible to stably couple the side plate 44 to the pipe portion 41A. The rear flange 44C protrudes laterally inward relative to the front flange 44B. A lower portion of the rear flange 44C protrudes laterally inward relative to an upper portion of the rear flange 44C. A lower end of the front flange 44B and a lower end of the rear flange 44C are connected to each other.

An upper portion 44D of the plate body 44A is arranged along the straight portion 41B. A lower portion 44E of the plate body 44A is arranged laterally outward of the bent portion 41C with a gap therebetween. The upper portion 44D and the lower portion 44E of the plate body 44A are arranged on the same plane extending in the up-and-down direction. The lower portion 44E of the plate body 44A protrudes forward relative to the upper portion 44D. The front-and-rear dimension of the lower portion 44E of the plate body 44A is greater than that of the upper portion 44D. A front edge of the lower portion 44E of the plate body 44A is formed in an arc shape.

The lower portion 44E of the plate body 44A is provided with a reinforcement bead 44F extending downward of the bent portion 41C. The reinforcement bead 44F extends along a front edge of the lower portion 44E of the plate body 44A. Accordingly, it is possible to reinforce the lower portion 44E of the plate body 44A extending downward to be away from the pipe portion 41A by the reinforcement bead 44F.

The side plate 44 is rotatably supported by the left support member 24 via a reclining device 50. Further, a lower end of the right back side member 41 is rotatably supported by the intermediate support member 27 via a reclining device 50. Each reclining device 50 includes an operation shaft 50A, and is switched between a locking state and a releasing state by rotation of the operation shaft 50A. In the locking state, the reclining device 50 prohibits the side plate 44 from rotating relative to the support member 24 or the intermediate support member 27. In the releasing state, the reclining device 50 allows the side plate 44 to rotate relative to the support member 24 or the intermediate support member 27. The reclining device 50 may include, for example, a first member coupled to the support member 24 or the intermediate support member 27, a second member supported rotatably relative to the first member and coupled to a lower end of the side plate 44 or the right back side member 41, and a locking member arranged between the first member and the second member and coupled to the operation shaft 50A. According to a rotational position of the operation shaft 50A, the locking member engages with the first member and the second member and thereby restricts the rotation of the second member relative to the first member in the locking position to engage with the first member and the second member and thereby restrict the rotation of the second member relative to the first member.

The support member upper portion 24B is provided laterally outward of the lower portion 44E of the plate body 44A with the reclining device 50 therebetween. The reclining device 50 is arranged to the left of the lower portion 44E of the plate body 44A of the side plate 44, and the support member upper portion 24B is arranged to the left of the reclining device 50.

The operation shaft 50A of each reclining device 50 penetrates the corresponding side plate 44 and protrudes laterally inward. A lever 50B coupled to the operation shaft 50A is arranged laterally inward of the lower portion 44E of the plate body 44A. A control cable 50C is connected to the lever 50B. The lever 50B is biased to a locking position by a spring 50D. A holder 50E that supports the control cable 50C and locks one end of the spring 50D is provided on the lower portion 44E of the side plate 44. When the control cable 50C is pulled, the lever 50B and the operation shaft 50A rotate, and the reclining device 50 becomes the releasing state. The reclining device 50 may be biased to the locking state.

When viewed in the lateral direction, the operation shaft 50A may be arranged forward of the inclined portion 41D of the pipe portion 41A. Further, when viewed in the lateral direction, the lever 50B may overlap with the inclined portion 41D of pipe portion 41A.

The second seat back frame 13 is rotatably supported by the seat cushion frame 11. The second seat back frame 13 includes left and right back side members 53 extending in the up-and-down direction, an upper member 54 extending in the lateral direction and connected to upper ends of the left and right back side members 53, a lower member 55 extending in the lateral direction and connected to lower ends of the left and right back side members 53, and left and right side plates 56 coupled to the lower ends of the left and right back side members 53, respectively. The left and right back side members 53 and the lower member 43 are formed by bending a single continuous pipe. The lower member 43 inclined downward toward the central portion thereof.

The left side plate 56 of the second seat back 4 is rotatably supported by the intermediate support member 27 via the reclining device 50, and the right side plate 56 of the second seat back 4 is rotatably supported by the right support member 24.

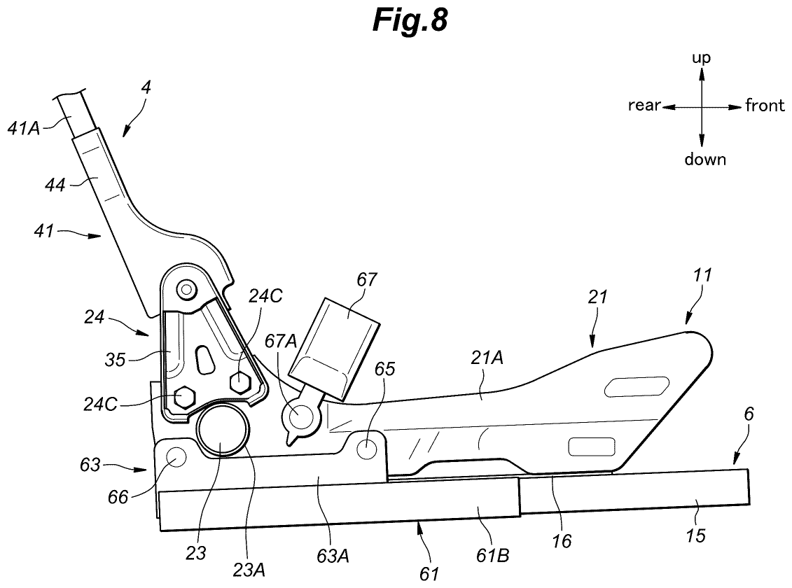

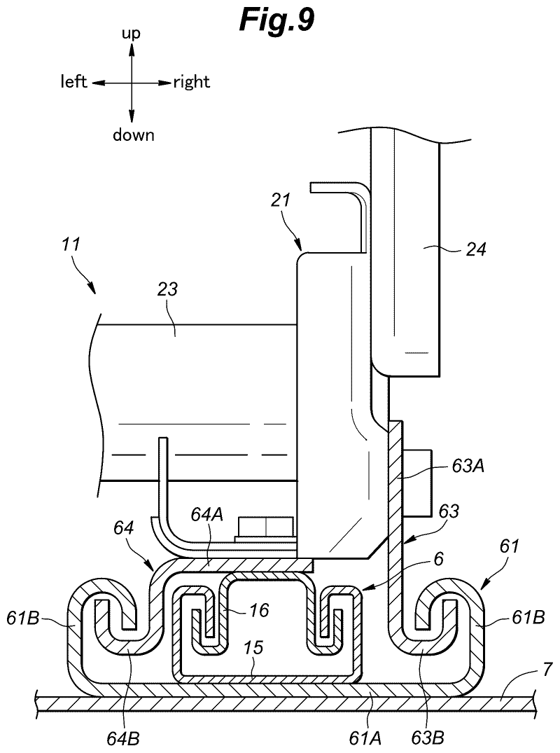

As shown in FIGS. 8 and 9, each of the lower rails 15 is provided with a lower locking member 61. The lower locking member 61 includes a bottom plate portion 61A, and left and right lower hooks 61B extending upward from left and right edges of the bottom plate portion 61A. The bottom plate portion 61A is provided between the floor 7 and the lower rail 15 and coupled to the lower rail 15 and the floor 7. The bottom plate portion 61A extends in the front-and-rear direction and has a lateral dimension wider than the lower rail 15. The left and right lower hooks 61B are arranged on left and right sides of the lower rail 15. Tip ends of the left and right lower hooks 61B are bent downward.

The right side member 21 is provided with a first upper locking member 63 and a second upper locking member 64. The first upper locking member 63 includes a side plate portion 63A having a surface facing the lateral direction and extending in the front-and-rear direction, and an upper hook 63B provided at a lower end of the side plate portion 63A. The side plate portion 63A is fastened to a laterally outer surface of the right side member 21 at a front coupling portion 65 and a rear coupling portion 66. The front coupling portion 65 and the rear coupling portion 66 are spaced in the front-and-rear direction. The front coupling portion 65 is arranged at a front end of the side plate portion 63A, and the rear coupling portion 66 is arranged at a rear end of the side plate portion 63A. The first upper locking member 63 may be fastened to the side member 21 at the front coupling portion 65 and the rear coupling portion 66.

A lower portion of the side plate portion 63A of the first upper locking member 63 protrudes between the lower rail 15 and the lower locking member 61. A tip end of the upper hook 63B is bent upward. The upper hook 63B is arranged below the lower hook 61B. The upper hook 63B and the lower hook 61B face each other with a gap in the up-and-down direction therebetween.

The second upper locking member 64 includes an upper plate portion 64A extending in the front-and-rear direction, and an upper hook 64B extending downward from a left end of the upper plate portion 64A. The upper plate portion 64A is sandwiched between a bottom surface of the right side member 21 and an upper surface of the upper rail 16, and is fastened to the right side member 21 and the upper rail 16. The lower portion of the upper hook 64B protrudes between the lower rail 15 and the lower locking member 61. A tip end of the upper hook 64B is bent upward. The upper hook 64B is arranged below the lower hook 61B. The upper hook 64B and the lower hook 61B face each other with a gap in the up-and-down direction therebetween.

When the seat 1 moves away from the floor 7 due to the load applied at a collision of the vehicle, the lower locking member 61 engages with the first upper locking member 63 and the second upper locking member 64, thereby restricting the movement of the seat 1. The left side member 21 may be provided with structures similar to the lower locking member 61, the first upper locking member 63, and the second upper locking member 64 with which the right side member 21 is provided.

A seat belt buckle 67 is coupled to the right side member 21. The seat belt buckle 67 is detachably coupled to a tongue provided on a seat belt. The seat belt may, for example, extend from a ceiling of the vehicle. The seat belt buckle 67 may be fastened to the right side member 21 at a coupling portion 67A.

A coupling portion 23A of the rear member 23 and the right side member 21 is provided rearward of the front coupling portion 65 and forward of the rear coupling portion 66. The rear member 23 and the right side member 21 may be welded to each other at the coupling portion 23A. The coupling portion 67A of the seat belt buckle 67 and the right side member 21 may be provided rearward of the front coupling portion 65 and forward of the coupling portion 23A of the rear member 23 and the side member 21. Accordingly, it is possible to couple the seat belt buckle 67 to a rigid portion of the side member 21. Accordingly, the coupling portion 67A of the seat belt buckle 67 and the side member 21 can resist the load applied from the occupant at a collision of the vehicle.

In the above-mentioned seat 1, when a load is applied to a seat back and the support member 24 deforms downward, the support member upper portion 24B contacts with the side member 21, which suppresses the deformation of the support member 24. Accordingly, it is possible to suppress the deformation of the support member 24 for supporting the first seat back frame 12 in the seat 1. Further, it is possible to reduce the weight and material of the support member 24.

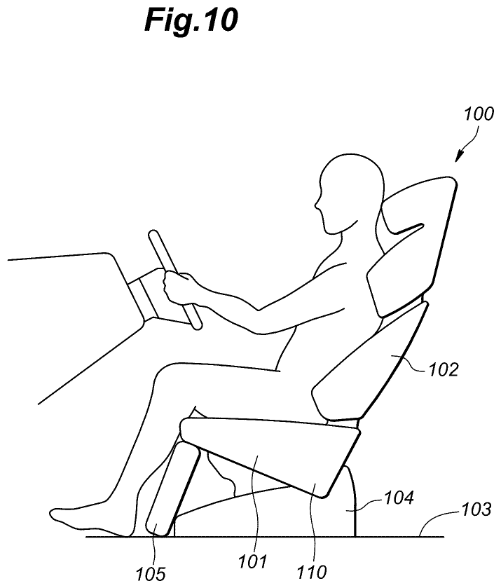

In the following, a vehicle seat according to another embodiment will be described. As shown in FIG. 10, a seat 100 includes a seat cushion 101 and a seat back 102. The seat cushion 101 is supported by a base 104 provided on a floor 103 such that the seat cushion 101 is rotatable around an axis extending in the lateral direction and slidable in the front-and-rear direction. The seat back 102 is supported by a rear portion of the seat cushion 101 such that the seat back 102 is rotatable around an axis extending in the lateral direction. An ottoman 105 may be rotatably supported by the front portion of the seat cushion 101.

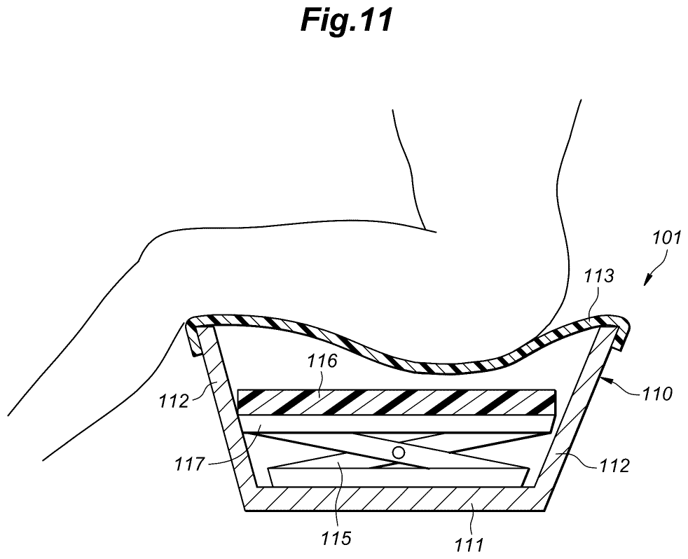

As shown in FIG. 11, the seat cushion 101 includes a case 110 that opens upward. The case 110 includes a bottom plate 111 and a sidewall 112 extending upward from an edge of the bottom plate 111. The sidewall 112 is formed in a tubular shape along a circumference of the bottom plate 111. The bottom plate 111 is supported by the base 104 such that the bottom plate 111 is rotatable around an axis extending in the lateral direction and slidable in the front-and-rear direction.

A first member 113 is coupled to an upper end of the sidewall 112. The first member 113 may be formed into a sheet-like shape and provided to close an opening of the case 110. An edge of the first member 113 may be coupled to an upper portion of the sidewall 112.

An elevating device 115 and a second member 116 are provided inside the case 110. The elevating device 115 is provided on an upper surface of the bottom plate 111. The elevating device 115 may include a driving source such as an electric motor and an electric air cylinder, and a link mechanism driven by the driving source. The link mechanism may be, for example, a pantographic arm.

A support portion 117 that supports the second member 116 is provided at an upper end of the elevating device 115. The support portion 117 may be a plate member facing the up-and-down direction. Further, the support portion 117 may be formed in a frame shape. The second member 116 is formed in a sheet-like shape and provided on an upper surface of the support portion 117. In a case where the support portion 117 is formed in a frame shape, the second member 116 may be coupled to an edge of the support portion 117 and close the opening.

The first member 113 and the second member 116 are each flexible. The first member 113 may be more flexible than the second member 116. The first member 113 and the second member 116 may be formed of a woven fabric, a rubber sheet, a resin sheet, and a foaming material such as urethane resin.

The seat cushion 101 stretches and contracts the elevating device 115, thereby changing the distance between the second member 116 and the first member 113. Accordingly, the hardness of a seating portion of the seat cushion 101 can be changed. As shown in FIG. 11, when an occupant sits on the seat cushion 101 in a soft mode in which a distance between the second member 116 and the first member 113 is sufficiently large, the first member 113 receives a load from the occupant, and a central portion of the first member 113 is bent downward. At this time, as the second member 116 is separated from the first member 113, the load of the occupant is supported only by the first member 113, and the deformation amount of the first member 113 becomes relatively large. Accordingly, the seat cushion 101 can provide the occupant with a soft sitting feeling.

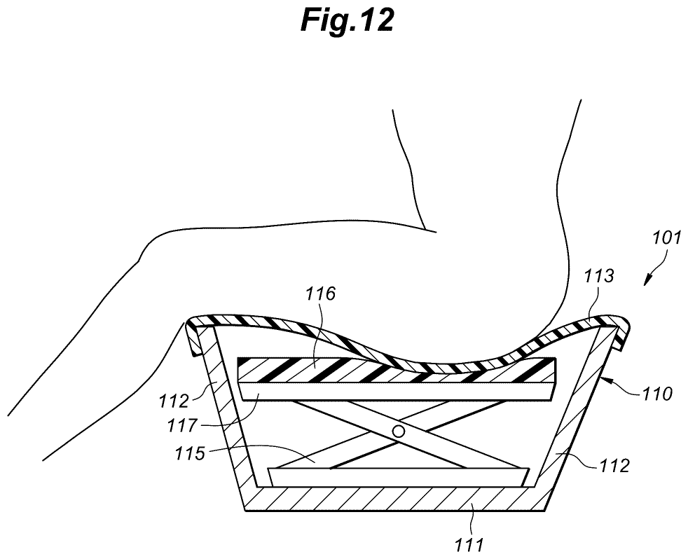

As shown in FIG. 12, when the occupant sits on the seat cushion 101 in a hard mode in which the distance between the second member 116 and the first member 113 is small, the first member 113 receives a load from the occupant, and the central portion of the first member 113 is lowered. At this time, the second member 116 contacts with a lower surface of the first member 113 and supports the first member 113 from below. Accordingly, the load of the occupant is supported by the first member 113 and the second member 116, and the deformation amount of the first member 113 becomes smaller than that in the soft mode. Accordingly, the seat cushion 101 can provide the occupant with a harder sitting feeling than the soft mode. According to the extension of the elevating device 115, as the second member 116 gets closer to the first member 113, the first member 113 gets unlikely to deform, and the seat cushion 101 becomes harder. In this manner, as the distance between the first member 113 and the second member 116 changes, the hardness of the seat cushion 101 changes.

The seat cushion 101 may change hardness according to a reclining state of the seat 100. That is, the elevating device 115 may be stretched or contracted according to the reclining state of the seat 100. For example, as the inclination angle of the seat back 102 relative to the vertical direction increases, the elevating device 115 may be contracted and the distance between the first member 113 and the second member 116 may increase.

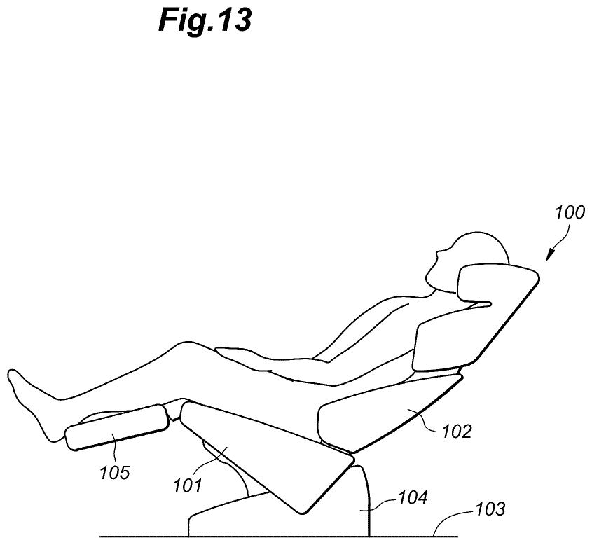

As shown in FIGS. 10 and 13, the seat 100 may change modes between a drive mode suitable for driving and a peace mode. In the peace mode shown in FIG. 13, the seat cushion 101 and the seat back 102 incline more rearward than the drive mode shown in FIG. 10. In the drive mode, the ottoman 105 is folded below the seat cushion 101. In the peace mode, the ottoman 105 extends forward from the seat cushion 101. The hardness of the seat cushion 101 may change according to the reclining state of the seat 100. That is, the elevating device 115 may be stretched or contracted according to the reclining state of the seat 100. When the seat 100 is in the peace mode, the elevating device 115 may be stretched or contracted as compared with the drive mode.

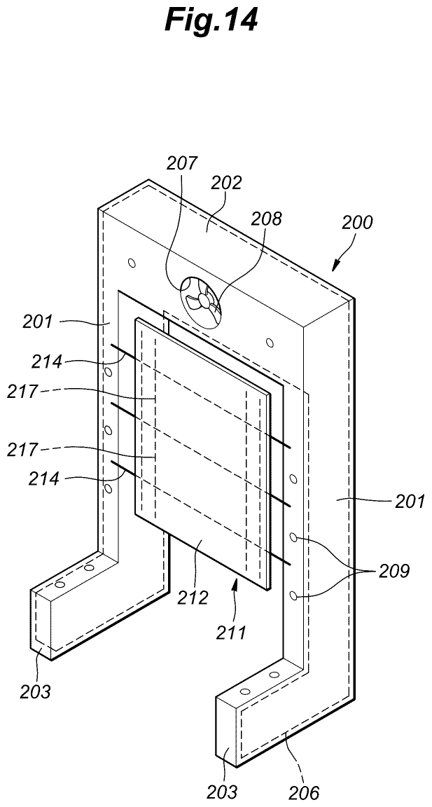

In another embodiment, a seat frame that forms a skeleton of the seat 100 is formed of a hollow tubular member. As shown in FIG. 14, the seat frame includes a seat cushion frame and a seat back frame. In the following, an example of a seat back frame 200 will be described.

The seat back frame 200 includes left and right side members 201 extending in the up-and-down direction, an upper member 202 extending in the lateral direction and coupled to upper ends of the left and right side members 201, and left and right lower members 203 extending forward from lower ends of the left and right side members 201. The lower ends of the left and right side members 201 may be coupled to the seat cushion frame. Each of the left and right side members 201, the upper member 202, and the left and right lower members 203 is formed of a tubular member. Each of the left and right side members 201, the upper member 202, and the left and right lower members 203 may be formed of a pipe material, or may be formed by combining sheet metal members. A continuous air introduction passage 206 is formed inside each of the left and right side members 201, the upper member 202, and the left and right lower members 203.

A suction port 207 connected to the air introduction passage 206 is formed in a central portion in the lateral direction on a front surface of the upper member 202. The suction port 207 is provided with an air blowing fan 208. The left and right side members 201, the upper member 202, and the left and right lower members 203 are provided with a plurality of discharge ports 209. As the air blowing fan 208 is driven, air is sucked from the outside into the air introduction passage 206 via the suction port 207 and discharged from the plurality of discharge ports 209.

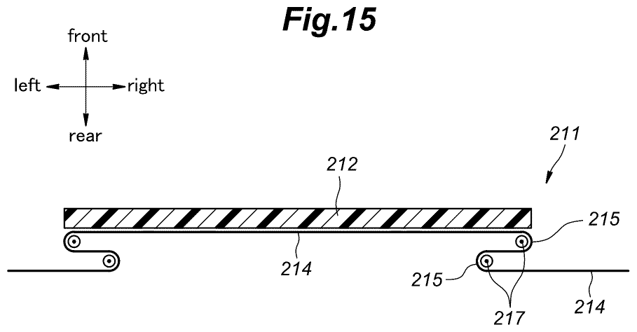

A pressure receiving member 211 that supports the back of an occupant from behind is attached to the left and right side members 201. The pressure receiving member 211 includes a flexible plate member 212 and a plurality of first wires 214 provided on the plate member 212. Each first wire 214 may be a flexible metal wire. As shown in FIG. 15, each first wire 214 extends in the lateral direction, and is coupled to the plate member 212 at the central portion of each first wire 214. Each first wire 214 is spaced in the up-and-down direction. Each first wire 214 includes a plurality of bent portions 215. Each bent portion 215 may be formed in an S-shape. The bent portion 215 improves the stretchability of the wire. The stretchability of the first wire 214 is adjusted by adjusting the number and shape of each bent portion 215.

The pressure receiving member 211 may also include a plurality of second wires 217. Each second wire 217 is coupled to the plate member 212. The second wires 217 extend in the up-and-down direction and are spaced from each other in the lateral direction. Each second wire 217 may pass inside the plurality of bent portions 215 of each first wire 214.

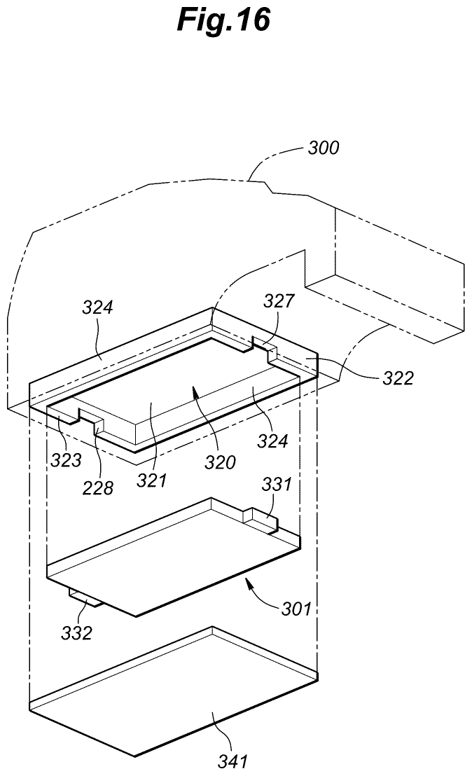

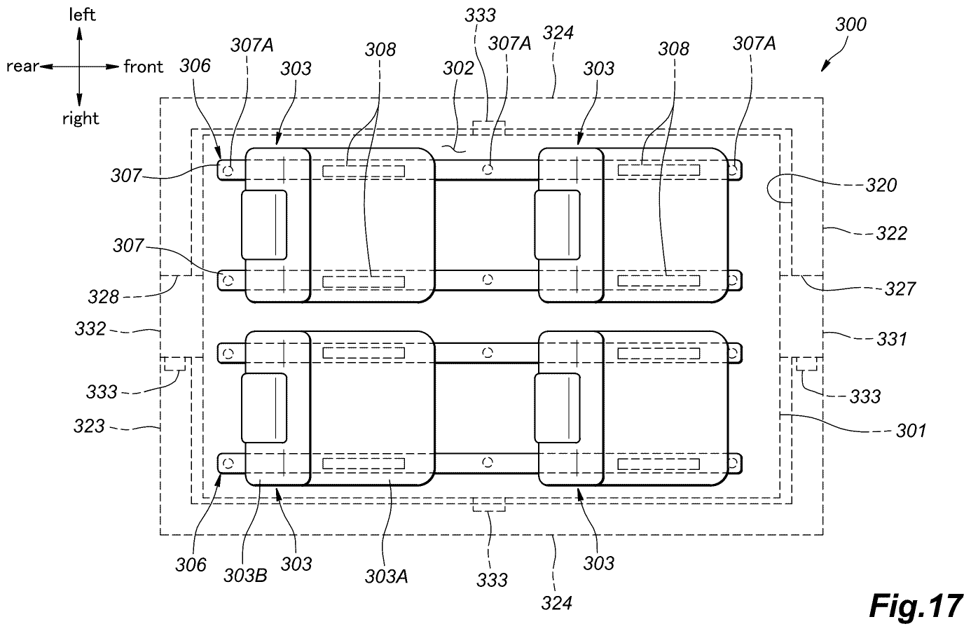

In another embodiment, as shown in FIG. 16, seats 303 provided in a vehicle 300 including a battery 301 below a floor 302 will be described. The vehicle 300 may be an electric vehicle. As shown in FIG. 17, the seats 303 include a front-row right seat 303, a front-row left seat 303, a rear-row right seat 303, and a rear-row left seat 303 that are provided in a vehicle cabin of the vehicle 300. Each seat 303 includes a seat cushion 303A and a seat back 303B. The front-row right seat 303 and the rear-row right seat 303 are mounted on the floor 302 via a right slide device 306. The front-row left seat 303 and the rear-row left seat 303 are mounted on the floor 302 via a left slide device 306. The right slide device 306 and the left slide device 306 have the same configuration.

The slide device 306 includes a left and right lower rails 307 extending in the front-and-rear direction, and left and right front upper rails 308 and left and right rear upper rails 308 slidably supported by the left and right lower rails 307. Each lower rail 307 is coupled to an upper surface of floor 302. The front-row left seat 303 is coupled to the left and right front upper rails 308 of the left slide device 306. The rear-row left seat 303 is coupled to the left and right rear upper rails 308 of the left slide device 306. The front-row right seat 303 is coupled to the left and right front upper rails 308 of the right slide device 306. The rear-row right seat 303 is coupled to the left and right rear upper rails 308 of the right slide device 306. The front upper rails 308 and the rear upper rails 308 can move independently of each other.

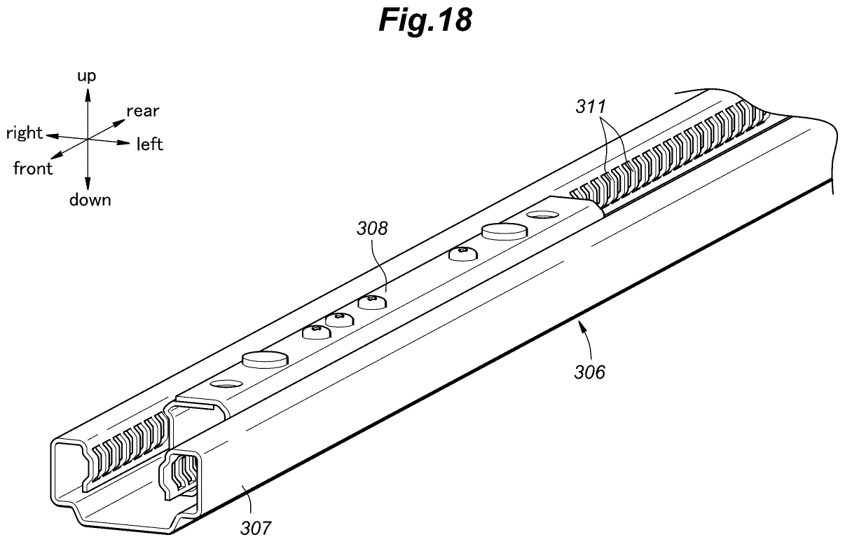

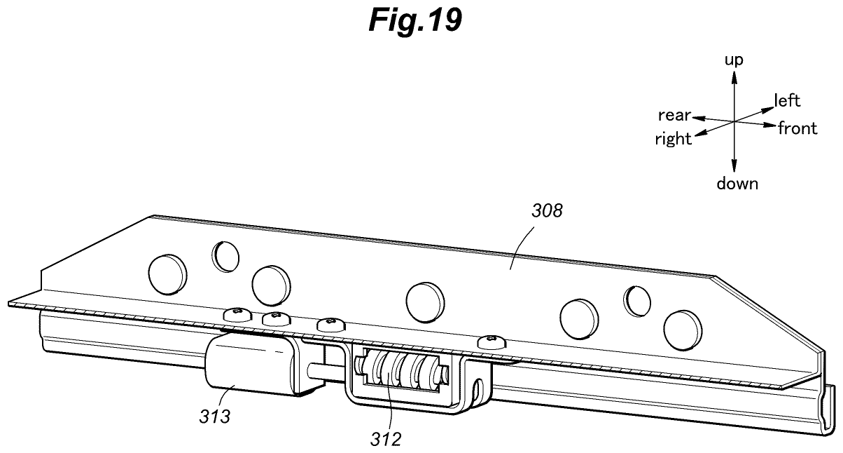

As shown in FIG. 18, a plurality of locking holes 311 are formed in a portion of each lower rail 307 facing each upper rail 308. The plurality of locking holes 311 is aligned in the front-and-rear direction. A screw shaft 312 having a male screw on an outer circumference thereof is rotatably supported by a lower portion of each upper rail 308. A rotation axis of the screw shaft 312 extends in the front-and-rear direction. The screw shaft 312 engages with the plurality of locking holes 311. As shown in FIG. 19, an electric motor 313 coupled to the screw shaft 312 is provided on a lower portion of the upper rail 308. A reducer may be provided between the electric motor 313 and the screw shaft 312. When the screw shaft 312 rotates according to the rotation of the electric motor 313, the upper rail 308 supporting the screw shaft 312 slides forward or rearward relative to the lower rail 307.

As shown in FIG. 16, a battery housing recess 320 is provided below the floor 302. The battery housing recess 320 includes an upper wall 321, a front wall 322, a rear wall 323, and left and right sidewalls 324. The upper wall 321 may be formed into a rectangle extending in the front-and-rear direction. The front wall 322 extends in the lateral direction along a front edge of the upper wall 321 and extends downward from the upper wall 321. The rear wall 323 extends in the lateral direction along a rear edge of the upper wall 321 and extends downward from the upper wall 321. The left and right sidewalls 324 extend in the front-and-rear direction along left and right side edges of the upper wall 321 and extend downward from the upper wall 321. Further, each sidewall 324 is connected to the front wall 322 and the rear wall 323. The battery housing recess 320 is defined by the upper wall 321, the front wall 322, the rear wall 323, and the left and right sidewalls 324 and opens downward. The dimension in the up-and-down direction of the battery housing recess 320 is smaller than both the dimension in the front-and-rear direction thereof and the dimension in the lateral direction thereof.

A front battery attachment portion 327 is provided at a lower end of a central portion in the lateral direction of the front wall 322. The front battery attachment portion 327 is a recess that is recessed upward from a lower edge of the front wall 322. The front battery attachment portion 327 may penetrate the front wall 322 in the front-and-rear direction. A rear battery attachment portion 328 is provided at a lower end of a central portion in the lateral direction of the rear wall 323. The rear battery attachment portion 328 is a recess that is recessed upward from a lower edge of the rear wall 323. The rear battery attachment portion 328 may penetrate the rear wall 323 in the front-and-rear direction.

The battery housing recess 320 houses the battery 301. The dimension in the up-and-down direction of the battery 301 is smaller than both the dimension in the front-and-rear direction thereof and the dimension in the lateral direction thereof. A front battery connection portion 331 connected to the front battery attachment portion 327 is provided at a front end of the battery 301. A rear battery connection portion 332 connected to the rear battery attachment portion 328 is provided at a rear end of the battery 301. The front battery connection portion 331 is detachably coupled to the front battery attachment portion 327. The rear battery connection portion 332 is detachably coupled to the rear battery attachment portion 328. As the front battery connection portion 331 is coupled to the front battery attachment portion 327 and the rear battery connection portion 332 is coupled to the rear battery attachment portion 328, the battery 301 is held in the battery housing recess 320. Further, electric power can be supplied from the battery 301 to the vehicle 300 as the front battery connection portion 331 and the front battery attachment portion 327 are electrically connected. Further, the electric power may be supplied from the battery 301 to the vehicle 300 as the rear battery connection portion 332 and the rear battery attachment portion 328 are electrically connected.

The front wall 322, the rear wall 323, and the left and right sidewalls 324 may be provided with locking portions 333 for fixing the battery 301 to the battery housing recess 320. In the front wall 322, the locking portion 333 may be provided on a lateral side of the front battery attachment portion 327. In the rear wall 323, the locking portion 333 may be provided on a lateral side of the rear battery attachment portion 328.

A protection member 341 is coupled to a lower end of the battery 301. The protection member 341 is formed in a plate shape, and protrudes laterally relative to the battery 301. The protection member 341 covers a lower portion of the battery 301 and an inside of the battery housing recess 320 from below. The protection member 341 is detachably coupled to the plurality of locking portions 333 provided on at least one of the front wall 322, the rear wall 323, and the left and right sidewalls 324.

As shown in FIG. 17, each lower rail 307 is coupled to the floor 302 via a plurality of coupling portions 307A. Each lower rail 307 may be directly coupled to the floor 302 at the coupling portions 307A. Further, each lower rail 307 may be coupled to the floor 302 via a foot. In this case, the coupling portions 307A of the lower rail 307 function as the coupling portions 307A of the foot and the floor 302. The foot may be formed of a sheet metal member. Each lower rail 307 may be fastened to the floor 302 at the coupling portions 307A.

As shown in FIG. 17, when viewed from above, the coupling portions 307A of each lower rail 307 may be provided at positions that do not overlap with each of the front battery attachment portion 327 and the rear battery attachment portion 328. That is, the coupling portions 307A of each lower rail 307 may be provided at positions that avoid positions directly above each of the front battery attachment portion 327 and the rear battery attachment portion 328. According to this aspect, it is possible to improve the mounting rigidity of each seat 303. Further, it is possible to avoid the interference between the coupling portions 307A of each lower rail 307 and both the front battery attachment portion 327 and the rear battery attachment portion 328.

In another example, when viewed from above, at least one of the coupling portions 307A of each lower rail 307 may be provided at a position that overlaps with each of the front battery attachment portion 327 and the rear battery attachment portion 328. That is, the coupling portions 307A of each lower rail 307 may be provided directly above each of the front battery attachment portion 327 and the rear battery attachment portion 328.

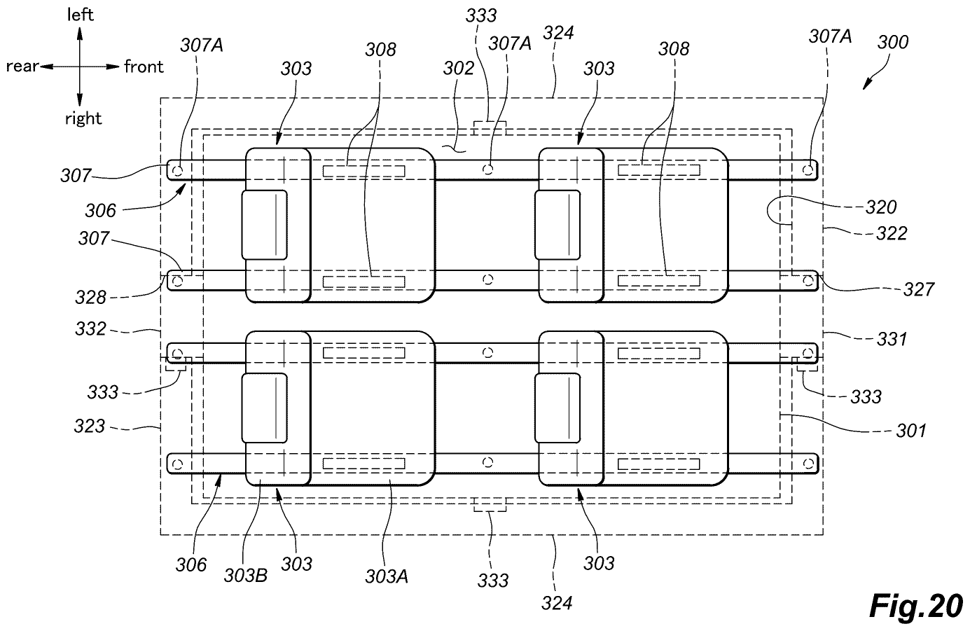

As shown in FIG. 20, when viewed from above, at least one of the coupling portions 307A of each lower rail 307 may be provided at a position that overlaps with the front wall 322 or the rear wall 323. More specifically, when viewed from above, the coupling portion 307A on a front end of the lower rail 307 may be provided at a position that overlaps with the front wall 322. Further, when viewed from above, the coupling portion 307A on a rear end of the lower rail 307 may be provided at a position that overlaps with the rear wall 323. In another example, when viewed from above, the plurality of coupling portions 307A of each lower rail 307 may be provided at positions that do not overlap with the front wall 322 or the rear wall 323.

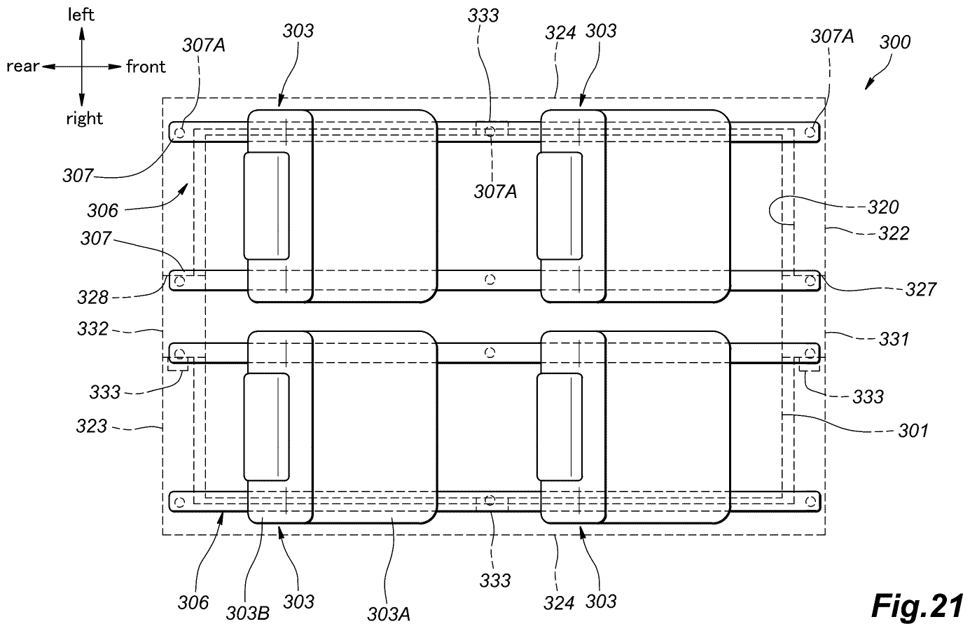

As shown in FIG. 21, when viewed from above, at least one of the coupling portions 307A of each lower rail 307 may be provided at a position that overlaps with the left and right sidewalls 324. More specifically, when viewed from above, the coupling portions 307A of the right lower rail 307 of the right slide device 306 may be provided at positions that overlap with the right sidewall 324. Further, when viewed from above, the coupling portions 307A of the left lower rail 307 of the left slide device 306 may be provided at positions that overlap with the left sidewall 324. In another example, when viewed from above, the coupling portions 307A of each lower rail 307 may be provided at positions that do not overlap with the left and right sidewalls 324.

The upper wall 321 may be provided with a reinforcement structure. In this case, when viewed from above, at least one of the coupling portions 307A of each lower rail 307 may be provided at a position that overlaps with a reinforcement member. The reinforcement structure may be a three-dimensional shape such as a bead or a bump, a thickened portion of the upper wall 321 having an increased thickness, or a reinforcement plate coupled to the upper wall 321. In another example, when viewed from above, the coupling portions 307A of each lower rail 307 may be provided at positions that do not overlap with the reinforcement structure.

When viewed from above, the plurality of locking portions 333 may be arranged at positions that do not overlap with the front battery attachment portion 327 and the rear battery attachment portion 328. That is, the plurality of locking portions 333 may be provided at positions that avoid the front battery attachment portion 327 and the rear battery attachment portion 328. In another example, when viewed from above, the plurality of locking portions 333 may be provided at positions that overlap with the front battery attachment portion 327 and the rear battery attachment portion 328.

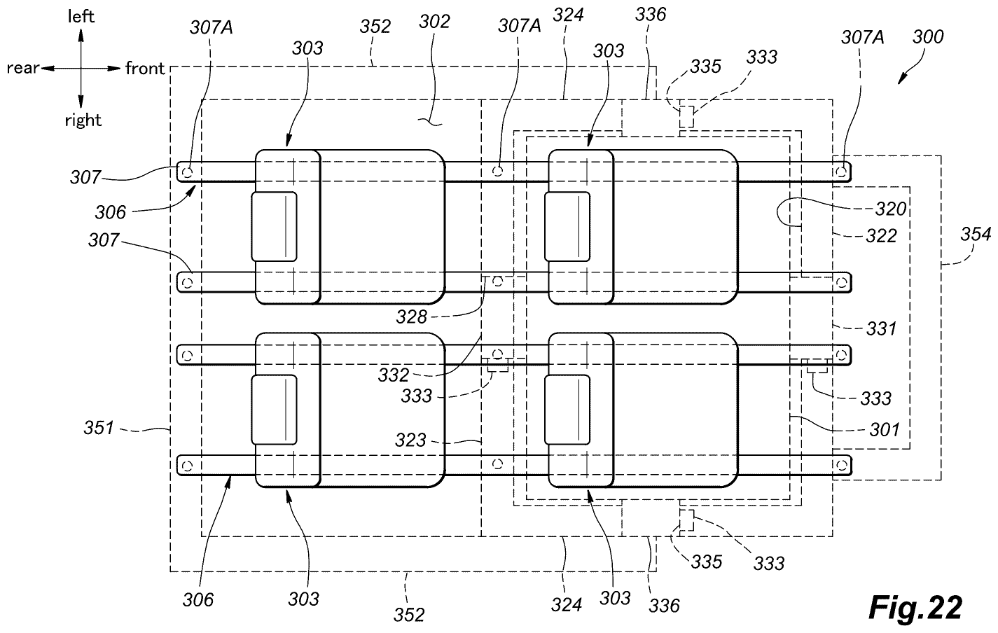

As shown in FIG. 22, a second rear wall 351 may be provided behind the rear wall 323. The second rear wall 351 protrudes downward from the floor 302 and extends in the lateral direction. Furthermore, left and right second sidewalls 352 may be provided laterally outward of the left and right sidewalls 324. Each second sidewall 352 protrudes downward from the floor 302 and extends in the front-and-rear direction. A rear end of each second sidewall 352 is connected to left and right ends of the second rear wall 351. A front portion of each second sidewall 352 extends along a laterally outer surface of the sidewall 324 corresponding thereto with respect to the lateral direction. A front end of each second sidewall 352 is arranged rearward of a front end of the sidewall 324 corresponding thereto with respect to the lateral direction. Further, a second front wall 354 and left and right third sidewalls 355 may be provided in front of the front wall 322. The second front wall 354 protrudes downward from the floor 302 and extends in the lateral direction. Each second sidewall 352 protrudes downward from the floor 302 and extends in the front-and-rear direction. The front end of each second sidewall 352 is connected to left and right ends of the second front wall 354. The rear end of each second sidewall 352 is connected to the front wall 322.

When viewed from above, each coupling portion 307A of each lower rail 307 may be arranged at a position that overlaps with the front wall 322, the rear wall 323, and the second rear wall 351. Further, when viewed from above, the coupling portion 307A on a front end of the lower rail 307 may be arranged at a position that overlaps with the third sidewall 355.

As shown in FIG. 22, each of the left and right sidewalls 324 may be provided with a battery attachment portion 335. In this case, battery connection portions 336 may be provided on left and right side edges of the battery 301.

In FIG. 22, the lower rail 307 arranged laterally outward may be provided at a position that overlaps with the sidewall 324.

In the following, another embodiment of the vehicle seat will be described. In this embodiment, an example of a seat that constitutes a rear seat of a passenger car will be described.

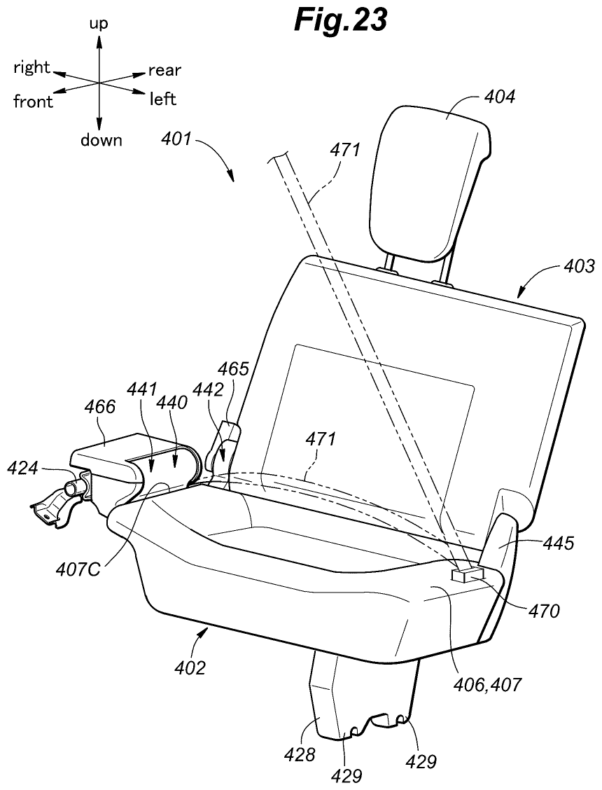

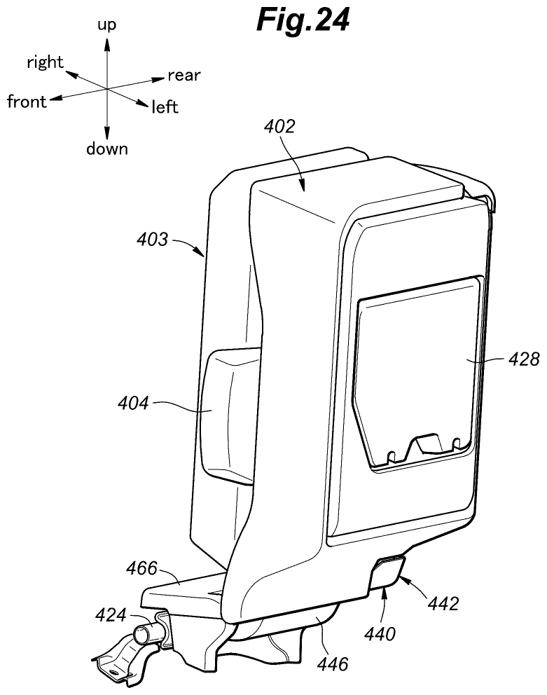

As shown in FIGS. 23 and 24, a seat 401 includes a seat cushion 402 and a seat back 403 rotatably supported by a rear portion of the seat cushion 402. The seat cushion 402 supports the buttocks of a user from below, and the seat back 403 supports the back of the user from behind. A headrest 404 is provided at an upper end of the seat back 403.

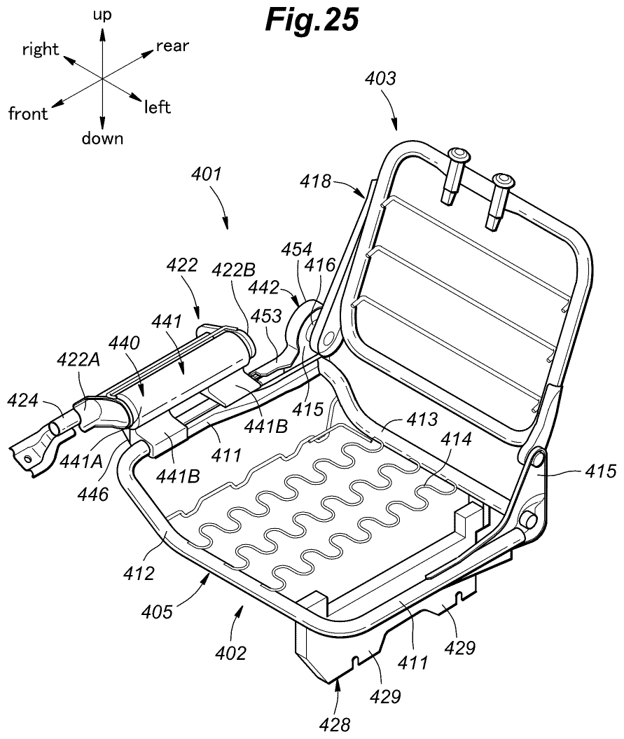

As shown in FIG. 25, the seat cushion 402 includes a seat cushion frame 405 that forms a skeleton, a pad 406 supported by the seat cushion frame 405, and a skin material 407 covering the pad 406. The seat cushion frame 405 includes left and right side members 411 extending in the front-and-rear direction, a front member 412 extending in the lateral direction and connected to front ends of the left and right side members 411, and a rear member 413 extending in the lateral direction and connected to rear ends of the left and right side members 411. A plurality of S-shaped springs 414 extending in the front-and-rear direction are stretched across the front member 412 and the rear member 413.

The seat cushion frame 405 includes seat back support portions 415 extending upward from rear portions of the left and right side members 411. A seat back frame 418 is coupled to the left and right seat back support portions 415 via a reclining device 416. The seat back frame 418 is supported by the left and right seat back support portions 415 such that the seat back frame 418 is rotatable around a rotation axis extending in the lateral direction. As shown in FIGS. 23 and 24, the seat back 403 rotates relative to the seat cushion 402 between an erected position to extend upward from a rear portion of the seat cushion 402 and a folded position to extend forward from the rear portion of the seat cushion 402 and to be folded over the seat cushion 402.

As shown in FIGS. 23 to 25, the seat cushion frame 405 is supported by a seat mount 424 provided on a vehicle body panel via an arm 421 and a support bracket 422. The arm 421 is welded to one of the side members 411 and extends upward from the side member 411. The arm 421 is welded to the side member 411 arranged on an outboard side. The support bracket 422 is coupled to the seat mount 424. The support bracket 422 supports an upper end of the arm 421 such that the upper end of the arm 421 is rotatable around an arm rotation axis Al extending in the front-and-rear direction. The support bracket 422 includes a front bracket 422A supporting a front end of the arm 421 and a rear bracket 422B supporting a rear end of the arm 421.

The seat cushion 402 rotates relative to a vehicle body around the arm rotation axis A1 extending in the front-and-rear direction. When the seat back 403 is in the folded position, the seat cushion 402 can rotate between a use position in which a seat surface faces upward and a storage position in which the seat surface faces a sidewall of the vehicle body. As shown in FIG. 23, when the seat cushion 402 is in the use position and the seat back 403 is in the erected position, the seat 401 is in a use mode. As shown in FIG. 24, when the seat cushion 402 is in the storage position and the seat back 403 is in the folded position, the seat 401 is in a storage mode. In the following, the positional relationships of each member will be described based on the use mode of the seat 401.

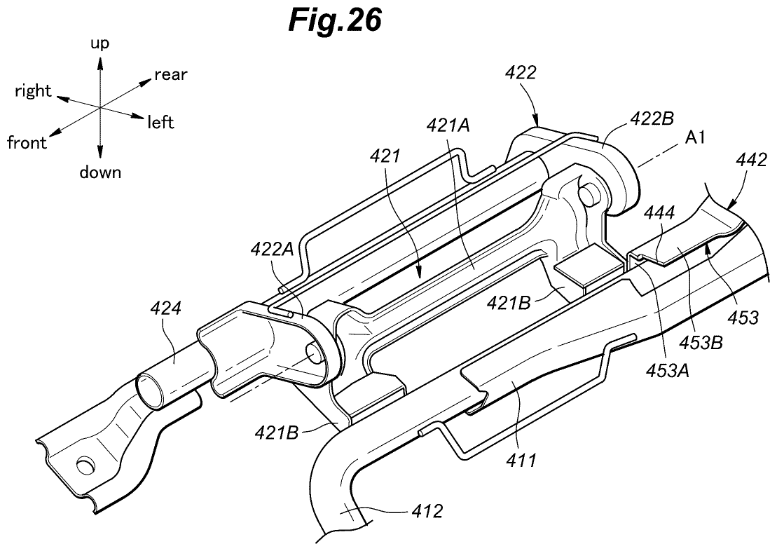

As shown in FIG. 26, the arm 421 includes an arm body 421A extending in the up-and-down direction and the front-and-rear direction and having an upper end supported by the support bracket 422, and a pair of front and rear arm couplings 421B extending laterally from a lower end of the arm body 421A and welded to the side member 411. The arm 421 may be formed of a sheet metal member.

As shown in FIGS. 23 to 25, a support leg 428 is coupled to the front member 412 and the rear member 413 such that the support leg 428 is rotatable around a rotation axis extending in the front-and-rear direction. Locking devices 429 are provided at a tip end of the support leg 428. When the seat cushion 402 is in the use position, The support leg 428 extends downward from the side member 411 and connects to a striker provided on the floor of the vehicle. When the seat cushion 402 is in the storage position, the support leg 428 extends downward from the front member 412 and the rear member 413 along a lower surface of the seat cushion 402.

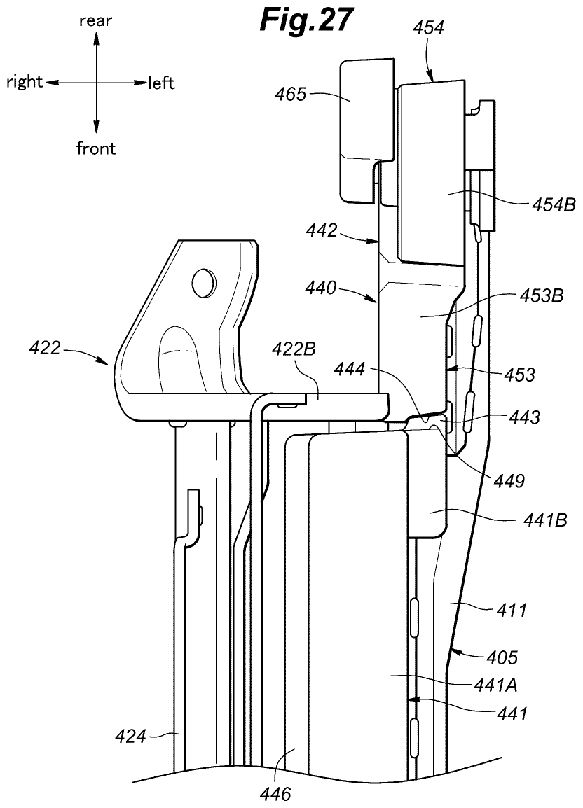

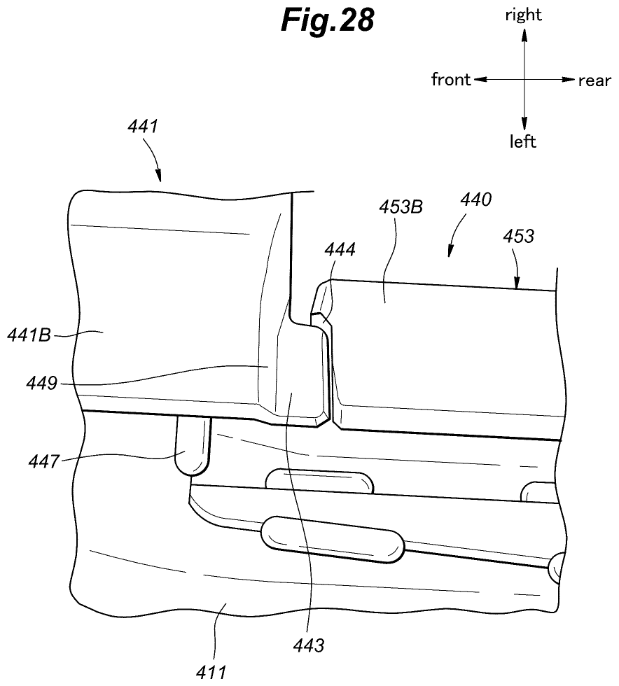

As shown in FIG. 25, at least one of the left and right side members 411 is provided with a protection cover 440. The side member 411 coupled to the arm 421, that is, the side member 411 on the outboard side is provided with the protection cover 440. In the present embodiment, the right side member 411 is provided with the protection cover 440. The protection cover 440 includes a first cover 441 and a second cover 442 provided forward or rearward of the first cover 441 and arranged adjacently thereto. As shown in FIGS. 27 and 28, a protrusion 443 extending toward a side of the second cover 442 is provided at an end of the first cover 441 on the side of the second cover 442. A recess 444 receiving the protrusion 443 is provided at an end of the second cover 442 on a side of the first cover 441. The recess 444 penetrates in a thickness direction of the second cover 442.

The side member 411 on the outboard side, that is, the left side member 411 is provided with a second protection cover 445. The second protection cover 445 covers side portions of the left side member 411 and the seat back support portion 415.

The first cover 441 includes a first cover upper portion 441A arranged along the arm body 421A, and a pair of front and rear first cover lower portions 441B arranged along the pair of front and rear arm couplings 421B. The first cover upper portion 441A is formed in a semi-cylindrical shape centered on a rotation axis extending in the front-and-rear direction. The first cover upper portion 441A protrudes toward an inboard side. When the seat cushion 402 is in the use position, the first cover upper portion 441A covers an upper side and a laterally inner side of the arm body 421A. An auxiliary cover 446 that covers the arm body 421A together with the first cover 441 is provided laterally outward of the arm body 421A.

As shown in FIG. 25, the front and rear first cover lower portions 441B are spaced in the front-and-rear direction, and extend laterally inward from the lower end of the arm body 421A. As shown in FIG. 25 and FIG. 28, the front and rear first cover lower portions 441B cover the upper portions of the arm couplings 421B corresponding thereto with respect to the front-and-rear direction, and extend above the side member 411 to which the front and rear arm couplings 421B are welded. The front and rear first cover lower portions 441B cover a welded portion 447 of each arm coupling 421B and the side member 411. The front-and-rear dimension of each first cover lower portion 441B is greater than the front-and-rear dimension of each arm coupling 421B.

As shown in FIGS. 27 and 28, a rear edge of the rear first cover lower portion 441B extends substantially in the lateral direction. The first cover lower portion 441B is provided with the protrusion 443. The protrusion 443 is provided on a rear edge of the first cover 441 and protrudes rearward. The protrusion 443 extends in the lateral direction. A rear edge of the protrusion 443 extends substantially in the lateral direction. When viewed from above, the protrusion 443 is formed into a rectangle extending in the lateral direction.

The restriction wall 449 protruding upward and extending in the lateral direction is provided on an upper surface of the first cover 441. The restriction wall 449 has a surface facing rearward. The restriction wall 449 is provided on an upper surface of the rear first cover lower portion 441B. The restriction wall 449 is arranged forward of the protrusion 443.

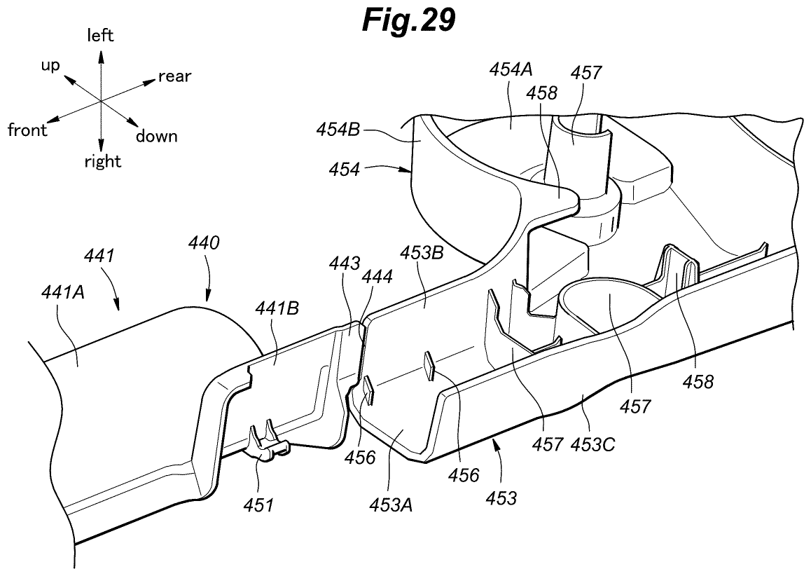

As shown in FIG. 29, the first cover 441 is locked at the arm 421 by a plurality of locking claws 451 provided on a back side of the first cover 441. Some of the locking claws 451 are provided on the first cover lower portion 441B.

As shown in FIGS. 27 to 29, the second cover 442 is arranged behind the first cover 441. The second cover 442 includes a second cover front portion 453 provided behind the first cover 441 and extending in the front-and-rear direction, and a second cover rear portion 454 extending rearward and upward from the second cover front portion 453 and covering at least a portion of the seat back support portion 415. The thickness of the second cover front portion 453 is set to be greater than the thickness of the second cover rear portion 454.

The second cover front portion 453 includes a sidewall 453A arranged laterally outward of the side member 411, an upper wall 453B extending laterally inward from an upper edge of the sidewall 453A, and a lower wall 453C extending laterally inward from a lower edge of the sidewall 453A. The sidewall 453A is formed in a plate shape facing the lateral direction, and the upper wall 453B and the lower wall 453C are formed in a plate shape facing the up-and-down direction.

The upper wall 453B of the second cover front portion 453 is provided with the recess 444. The recess 444 is provided on a front edge of the upper wall 453B of the second cover front portion 453, and is recessed toward the rear. Further, the recess 444 penetrates the upper wall 453B of the second cover front portion 453 in the up-and-down direction. The protrusion 443 enters the recess 444. A small gap may be formed between the recess 444 and the protrusion 443.

The second cover rear portion 454 includes a sidewall 454A arranged laterally outward of the side member 411 and the seat back support portion 415, and an edge wall 454B extending laterally inward from an edge of the sidewall 454A. The sidewall 454A of the second cover rear portion 454 has a surface facing the lateral direction, and is continuous with the sidewall 453A of the second cover front portion 453. The sidewall 454A of the second cover rear portion 454 extends upward relative to the sidewall 453A of the second cover front portion 453. A front end of the edge wall 454B is connected to a rear end of the upper wall 453B of the second cover front portion 453. The edge wall 454B is arranged in front of, above, and at the rear of the seat back support portion 415.

One or more ribs 456 extending in the lateral direction are provided on the back of the second cover front portion 453. The ribs 456 extend from the back of the upper wall 453B of the second cover front portion 453 to the back of the sidewall 453A of the second cover front portion 453. At least one of the ribs 456 is arranged on a lateral side of the recess 444. The ribs 456 may be arranged forward of a rear end of the recess 444. The ribs 456 improve the rigidity of the second cover 442. In particular, the ribs 456 improve the rigidity of a portion around the recess 444.

A plurality of spacers 457 that abuts against the side member 411 or the seat back support portion 415 is provided on the back of the second cover 442. The spacers 457 extend laterally inward from the sidewall 453A of the second cover front portion 453 or the sidewall 454A of the second cover rear portion 454.

The second cover 442 may be locked at the side member 411 by one or more locking claws 458. The locking claws 458 may be provided at an edge of the edge wall 454B and at the sidewall 454A.

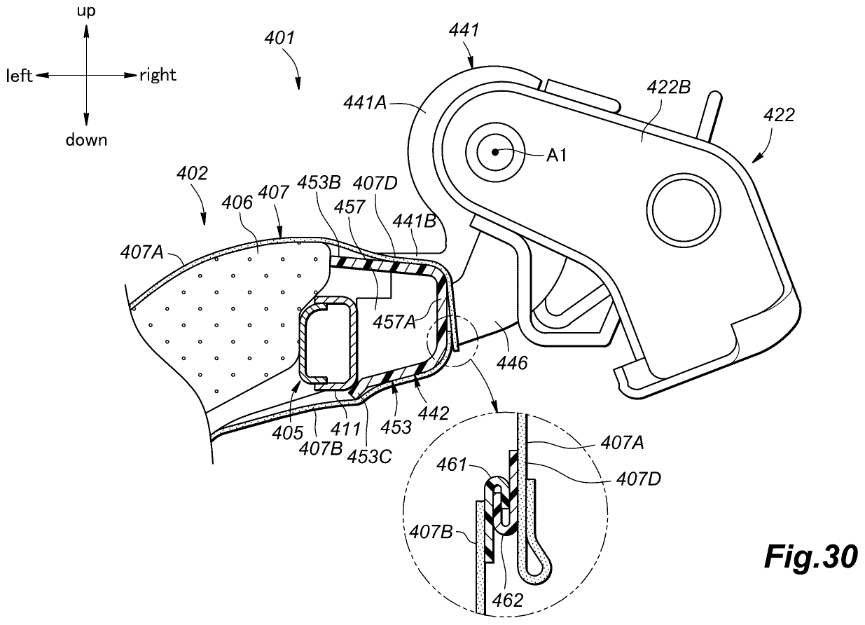

As shown in FIG. 30, the skin material 407 covers the first cover lower portion 441B and the second cover front portion 453. The skin material 407 includes an upper skin material 407A covering an upper surface of the seat cushion 402, and a lower skin material 407B covering a lower surface of the seat cushion 402. The upper skin material 407A and the lower skin material 407B are detachably coupled to each other at a side edge (a right side edge) on a side of the arm 421. The upper skin material 407A and the lower skin material 407B may be sewn together or detachably coupled to each other at another side edge other than the side edge on the side of the arm 421.

As shown in FIG. 23, a side portion of the upper skin material 407A on the side of the arm 421 is provided with a notch 407C that is recessed laterally inward. The side portion of the upper skin material 407A on the side of the arm 421 is partitioned by the notch 407C into front and rear extensions 407D. An arm 421 covered with the first cover 441 is arranged in the notch 407C. The front extension 407D passes the front of the arm 421 and extends downward. The rear extension 407D passes the rear of the arm 421 and extends downward. The front extension 407D covers the front first cover lower portion 441B and a laterally outer surface of the side member 411. The rear extension 407D covers a boundary between the first cover 441 and the second cover 442, that is, the protrusion 443 and the recess 444. The rear extension 407D covers the rear first cover lower portion 441B and the second cover front portion 453. An upper locking member 462 detachably locked by the lower locking member 461 provided on the side edge of the lower skin material 407B is provided at lower ends of the front and rear extension 407D. The lower locking member 461 and the upper locking member 462 may be hooks that engage with each other. In another embodiment, the lower locking member 461 and the upper locking member 462 may be a hook-and-loop fastener.

The reclining device 416 includes an operation lever 465. The operation lever 465 penetrates the sidewall 454A of the second cover rear portion 454 and extends to the outside. The support bracket 422 is covered with the bracket cover 466.

A buckle 470 is provided on a left rear portion of an upper surface of the seat cushion 402. A tongue provided on a seat belt 471 is coupled to the buckle 470. The buckle 470 may be coupled to the left side member 411, and penetrate the pad 406 and the skin material 407 to be exposed on the upper surface of the seat cushion 402.

Upper and lower ends of the seat belt 471 extend from the vehicle body arranged on a right side of the seat 401. The upper and lower ends of the seat belt 471 are provided with retractors for winding up the seat belt 471. In a use state of the seat belt 471, the seat belt 471 passes above the second cover front portion 453 and at the rear of the arm 421, and extends to the buckle 470.

In the following, the effect of the seat 401 according to the embodiment will be described. Since the protrusion 443 does not overlap with the second cover 442 in the thickness direction of the second cover 442, the thickness of the protection cover 440 can be reduced. Further, since the protrusion 443 can be seen from the outside when the protection cover 440 is attached to the side member 411 and the arm 421, the positioning of the first cover 441 and the second cover 442 can be facilitated. Accordingly, it is possible to reduce the thickness of the protection cover 440 and facilitate the positioning of the protection cover 440 in the seat 401. Further, as the protrusion 443 fits into the recess 444, the boundary between the first cover 441 and the second cover 442 meanders. Accordingly, the seat belt 471 is unlikely to enter the boundary between the first cover 441 and the second cover 442.

The second cover 442 includes the second cover rear portion 454 covering the seat back support portion 415. Accordingly, the protection cover 440 can protect the seat back support portion 415. The thickness of the second cover front portion 453 is greater than the thickness of the second cover rear portion 454. Accordingly, the rigidity of the second cover front portion 453 that may receive a load from the seat belt 471 can be increased. The first cover 441 can protect the arm 421 rotatably supporting the seat 401 relative to the vehicle body.

The first cover 441 covers the welded portion 447 of the arm 421 and the side member 411. Accordingly, it is possible to prevent the seat belt 471 from contacting with the welded portion 447 of the arm 421 and the side member 411. The restriction wall 449 can restrict the forward movement of the seat belt 471.

The skin material 407 covers the boundary between the first cover 441 and the second cover 442. Accordingly, the seat belt 471 is unlikely to enter the boundary between the first cover 441 and the second cover 442.

Concrete embodiments of the present invention have been described in the foregoing, but the present invention should not be limited by the foregoing embodiments and various modifications and alterations are possible. In another embodiment, the arm 421 may be omitted and the seat cushion 402 may be fixed to the floor. Further, the seat cushion 402 may be fixed to the floor via a slide device. Further, the second cover 442 may be arranged forward of the first cover 441.

### GLOSSARY OF TERMS

1: seat
2: seat cushion
3: first seat back
4: second seat back
11: seat cushion frame
12: first seat back frame
13: second seat back frame
21: side member
21A: side member body
21B: side member extension
21C: protrusion
21D: edge wall
22: front member
23: rear member
24: support member
24A: support member lower portion
24B: support member upper portion
24C: fastening portion
24D: receiving groove
24E: edge wall
24F: bulging portion
35: reinforcement plate
41: side pipe
41A: straight portion
41B: bent portion
41C: inclined portion
42: upper pipe
43: lower pipe
44: side plate
44A: plate body
44B: front flange
44C: rear flange
44D: upper portion
44E: lower portion
44F: reinforcement bead
50: reclining device
50A: operation shaft
50B: lever
61: lower locking member
63: first upper locking member
64: second upper locking member
65: front coupling portion
66: rear coupling portion
67: seat belt buckle
67A: coupling portion

1. A vehicle seat, comprising:
a seat cushion frame; and
a seat back frame rotatably supported by the seat cushion frame,
wherein the seat cushion frame includes:
left and right side members extending in a front-and-rear direction;
a front member extending in a lateral direction and coupled to a front portion of each of the side members;
a rear member extending in the lateral direction and coupled to a rear portion of each of the side members; and
support members coupled to a rear end of each of the side members and extending upward,
at least one of the support members includes:
a support member lower portion coupled to a laterally outer surface of the side member; and
a support member upper portion extending upward and laterally inward from the support member lower portion and rotatably supporting the seat back frame, and
when viewed in an up-and-down direction, the support member upper portion overlaps with the side member.

2. The vehicle seat according to claim 1, wherein the side member includes:
a side member body extending in the front-and-rear direction; and
a side member extension protruding upward from a rear end of the side member body,
the support member lower portion is coupled to the side member extension, and
when viewed in the up-and-down direction, the support member upper portion overlaps with the side member extension.

3. The vehicle seat according to claim 2, wherein one of the side member extension and the support member lower portion is provided with a protrusion extending in the up-and-down direction, and
another of the side member extension and the support member lower portion is provided with a receiving groove that receives the protrusion.

4. The vehicle seat according to claim 3, wherein the protrusion is provided on each of front and rear edges of the side member extension, and
the receiving groove is provided on each of front and rear edges of the support member lower portion.

5. The vehicle seat according to claim 4, wherein the support member is formed of a sheet metal member, and
edge walls protruding laterally outward and extending from the support member lower portion to the support member are provided on front and rear edges of the support member.

6. The vehicle seat according to claim 5, wherein a reinforcement plate is provided on a laterally outer surface of the support member, and
the reinforcement plate is coupled to the front and rear edge walls.

7. The vehicle seat according to claim 6, wherein the support member upper portion is provided with a bulging portion bulging laterally inward,
the seat back frame is rotatably supported by the bulging portion, and
the bulging portion is spaced upward relative to an upper edge of the side member extension.

8. The vehicle seat according to claim 1, wherein the left and right side members are coupled to a floor via a slide device,
the slide device includes:
a lower rail coupled to the floor; and
an upper rail provided slidably relative to the lower rail and coupled to the side member,
the lower rail is provided with a lower locking member extending in the front-and-rear direction and having a tip end facing downward,
the side member is provided with an upper locking member extending in the front-and-rear direction and having a tip end facing upward,
the upper locking member faces the lower locking member from below with a gap therebetween, and is coupled to the side member at a front coupling portion and a rear coupling portion that are spaced in the front-and-rear direction,
a coupling portion of the rear member and the side member is provided rearward of the front coupling portion and forward of the rear coupling portion, and
a coupling portion of a seat belt buckle and the side member is provided rearward of the front coupling portion and forward of the coupling portion of the rear member and the side member.

9. The vehicle seat according to claim 1, wherein the seat back frame includes:
left and right back side members extending in the up-and-down direction;
an upper member extending in the lateral direction and connected to upper ends of the left and right back side members; and
a lower member extending in the lateral direction and connected to lower ends of the left and right back side members,
at least one of the back side members includes:
a pipe portion extending in the up-and-down direction; and
a side plate coupled to a lower portion of the pipe portion, the side plate includes:
a plate body extending in the up-and-down direction and facing the lateral direction; and
front and rear flanges protruding laterally inward from front and rear edges of the plate body,
the pipe portion includes:
a straight portion extending straight in the up-and-down direction; and
an inclined portion extending downward and laterally inward from a bent portion provided at a lower end of the straight portion,
an upper portion of the plate body is arranged along the straight portion,
a lower portion of the plate body is arranged laterally outward of the bent portion with a gap therebetween,
the lower portion of the plate body is provided with a reinforcement bead extending downward of the bent portion,
the support member upper portion is provided laterally outward of the lower portion of the plate body with a reclining device therebetween, and
a lever coupled to an operation shaft of the reclining device is arranged laterally inward of the lower portion of the plate body.

10. The vehicle seat according to claim 9, wherein the front flange is welded to the straight portion, and
the rear flange is welded to the straight portion and the inclined portion.
